(19) United States
(12) Patent Application Publication
(10) Pub. No.: US 2008/0274941 A1
(43) Pub. Date: Nov. 6, 2008

(54) DETERGENT OR CLEANSER DOSING UNIT

(76) Inventors: Wolfgang BARTHEL, Langenfeld (DE); Salvatore FILECCIA, Oberhausen (DE); Ulf Arno TIMMANN, Koln (DE)

Correspondence Address: PAUL & PAUL, 2000 MARKET STREET, Suite 2900, PHILADELPHIA, PA, 19103-3229, US

(21) Appl. No.: 11/925,636

(22) Filed: Oct. 26, 2007

Related U.S. Application Data
(63) Continuation of application No. PCT/EP2006/002998, filed on Apr. 1, 2006.

(30) Foreign Application Priority Data
Apr. 27, 2005 (DE) 10 2005 020 009.5

(51) Int. Cl. C11D 17/00

(52) U.S. Cl. 510/445

(57) ABSTRACT

A process for manufacturing a detergent or cleaning agent dosing unit is comprised of the steps of: (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the rim; (c) filling the cavity; (d) applying a second water-soluble film over the filled cavity and sealing the cavity filled in step c).

### CROSS-REFERENCE TO RELATED APPLICATIONS

This application is a continuation under 35 U.S.C. § 365(c) and 35 U.S.C. § 120 of International Application No. PCT/EP2006/002998, filed Apr. 1, 2006. This application also claims priority under 35 U.S.C. § 119 of German Patent Application No. DE 10 2005 020 009.5, filed Apr. 27, 2005. Both the International Application and the German Application are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention lies in the field of detergents and cleaning agents. In particular, the present invention relates to a process for manufacturing detergents or cleaning agents, especially dosing units of detergents or cleaning agents.

Nowadays, detergents or cleaning agents are available to the consumer in a variety of commercial forms. In addition to washing powders and granulates, this range also includes, for example, cleaning agent concentrates in the form of extruded or tableted compositions. These solid, concentrated or densified commercial forms are characterized by a reduced volume per dosing unit and thereby lower the transport and packaging costs. In particular, such detergent or cleaning agent tablets also fulfill the wish of the consumer for easy dosing. Such compositions are extensively described in the prior art. Besides the cited advantages, however, compacted detergents or cleaning compositions possess a number of disadvantages. In particular, products in the form of tablets, due to their high densification, are often prone to a delayed disintegration and thereby a delayed release of their ingredients. To solve this “conflict” between adequate tablet hardness and short disintegration times, numerous technical solutions have been disclosed in the patent literature, wherein here, reference can be made, for example, to the use of tablet disintegrators. These disintegration accelerators are added to the tablets in addition to the active detergent and cleaning substances, and generally do not possess any active detergent or cleaning properties and therefore increase the complexity and the costs of these compositions. Another disadvantage of tableting mixtures of active substances, particularly mixtures comprising active detergent or cleaning substances, is that the pressure exerted during tablet compaction can inactivate the active substances. Tableting creates much greater contact surfaces of the ingredients, with the result that chemical reactions can also inactivate the active substances.

In recent years, solid or liquid detergents or cleaning compositions having a water-soluble or water-dispersible packaging have been increasingly described as an alternative to the above-mentioned particulate or compacted detergents or cleaning compositions. Like tablets, these compositions are characterized by a simpler dosing because they can be dosed along with the surrounding packaging into the washing machine or the automatic dishwasher, secondly, however, at the same time they also allow detergents or cleaning agents in liquid or powder form to be packaged, which exhibit a better dissolution and faster efficiency than the compacted forms.

(2) Description of Related Art, Including Information Disclosed Under 37 C.F.R. §§ 1.997 and 1.98.

Thus, the EP 1 314 654 A2 (Unilever) discloses a dome-shaped pouch with a receiving chamber that contains a liquid.

On the other hand, pouches that contain two solids in particulate form in a receiving chamber, each solid being in fixed regions and which do not mix with each other, are the subject of the WO 01/83657 A2 (Procter & Gamble).

In addition to the packaging types that only have one receiving chamber, other product forms that include more than one receiving chamber or more than one conditioned form, have been disclosed in the prior art.

The subject of the European application EP 1 256 623 A1 (Procter & Gamble) is a kit of at least two pouches with a different composition and a different visual appearance. The pouches are separate from each other and are not present as a compact single product.

A process for manufacturing multi-chamber pouches by gluing two single chambers together is described in the international application WO 02/85736 A1 (Reckitt Benckiser).

The object of the present application is to provide a process for manufacturing detergents or cleaning agents, which allows solid and liquid or free-flowing detergents or cleaning agent compositions to be packaged together in zones that are separate from each other in a compact dosing unit. The appearance of the end product of the process should be appealing. The resulting dosing units should preferably be able to be marketed without additional packaging or with significantly reduced packaging costs. This object is achieved by a process, in which the water-soluble film materials employed for packaging the free-flowing detergent or cleaning agent compositions are simultaneously employed as the packaging material for the whole dosing unit.

### BRIEF SUMMARY OF THE INVENTION

Accordingly, a first subject matter of the present application is a process for manufacturing a detergent or cleaning agent dosing unit comprising the steps of: (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the rim; (c) filling the cavity; (d) applying a second water-soluble film over the filled cavity and sealing the cavity filled in step c).

### BRIEF DESCRIPTION OF THE SEVERAL VIEWS OF THE DRAWING(S)

Not Applicable

### DESCRIPTION OF THE PREFERRED EMBODIMENTS

The sizes of the shaped detergent and/or cleaning agent premix advantageously match the dimensions of the dispensing draws of commercial washing machines or automatic dishwashers, such that they can be dosed directly into the corresponding compartment of the dispensing draw. Alternatively, however, the inventive molded bodies can also of course be dosed directly into the drum or inside the washing machine, optionally with the help of dosing aids.

In the context of the present invention, molded objects of practically all imaginable handleable designs can be employed, thus, for example, plates, bars, rods, cubes, squares and corresponding shapes with flat sides and especially cylindrical designs with circular or oval cross sections. This last design includes the presentation form from the actual tablets to the compact cylindrical pieces having a height to diameter ratio greater than 1. Additional preferred geometrical shapes that can be manufactured by one of the shaping processes cited below are, in particular, concave, convex, biconcave, biconvex, cubic, tetragonal, orthorhombic, cylindrical, spherical, cylindrically segmental, plate like, tetrahedral, dodecahedral, octahedral, conical, pyramidal, elliptical, pentagonally, heptagonally and octagonally prismatic and rhombohedral. Completely irregular shapes such as arrow shapes or animal shapes, trees, clouds, and the like, can also be produced in shaping processes. If the molded objects have corners and edges then these are preferably rounded. An embodiment with rounded corners and beveled edges is preferred as an additional visual differentiation.

Independently of their geometry or structure, the single or multiphase tablets employed in the inventive process possess a cavity. As already described for the molded bodies, the shape of the cavity can be chosen at will, wherein molded bodies, especially tablets, are preferred, in which at least one cavity possesses a round or oval opening surface with one, two, three, four, five, six, seven, eight or a plurality of corners. The cavities can be defined by concave or convex floor areas and can assume cubic, tetragonal, orthorhombic, cylindrical, spherical, cylindrically segmental, plate like, tetrahedral, dodecahedral, octahedral, conical, pyramidal, elliptical, pentagonally, heptagonally and octagonally prismatic and rhombohedral shapes. Completely irregularly shaped cavities such as arrow shapes or animal shapes, trees, clouds, and the like, can also be produced. As with the molded bodies, cavities with rounded corners and edges or with rounded corners and beveled edges are also preferred. In two or multiphase molded objects, the described cavity is not necessarily limited to the confines of one of the external phases, but rather in specific development types may also extend over one or more phase interfaces into one or more additional phases. The size of the cavity in proportion to the whole molded object depends on the desired end-use of the molded object. The size of the cavity can vary according to whether one intends to fill the cavity and with which substances in which physical states. Independently of the end-use, detergent and cleaning agent tablets are preferred, in which the volume ratio of the base molded object to the cavity volume is in the range 1:1 to 100:1, preferably 2:1 to 80:1, particularly preferably 3:1 to 50:1 and particularly 4:1 to 30:1.

The absolute volume of the cavity is advantageously between 1 and 100 ml, preferably between 1 and 50 ml, particularly preferably between 1 and 30 ml and especially between 2 and 20 ml.

Similar statements can be made concerning the surface areas of the base molded object and the cavity opening which make up the total surface of the molded object. Here, detergent and cleaning agent tablets are preferred, in which the surface area of the cavity opening accounts for 1 to 25%, preferably 2 to 20%, particularly preferably 3 to 15% and especially 4 to 10% of the total surface area of the tablet.

For example, if the whole molded object measures 20×20×40 mm and therefore has a total surface area of 40 cm², then cavities are preferred that have a surface area of 0.4 to 10 cm², preferably 0.8 to 8 cm², particularly preferably 1.2 to 6 cm² and especially 1.6 to 4 cm².

The cavity of the molded object of the detergent or cleaning agent is circumscribed by a surrounding rim. This rim serves as a contact area for the water-soluble film that is attached in step b). In addition, as is presented in detail below, an adherent joint is produced particularly preferably in the region of this rim between the molded object and the water-soluble film attached in step b) and/or between the water-soluble film attached in step b) and that in step d). As both the stability of the molded object of the detergent or cleaning agent itself as well as the stability of the above-mentioned adherent joint is increased with increasing width of the rim, those manufacturing processes are preferred, in which the width of the rim is at least 1.5 mm, preferably at least 2 mm and especially between 2 and 10 mm.

In principle, all shaping processes known to the person skilled in the art are suitable for manufacturing the single or multi-phase molded objects of the detergent or cleaning agent provided in step a), wherein in the present case tableting and/or extrusion and/or roll compaction and/or solidifying and/or sintering and/or crystallization, although, in particular, tableting, are preferred.

In the context of the present invention, a preferred shaping process according to the above statements is the tableting of the detergent and/or cleaning agent premix. The tablets that result from this process can be single or multi-phase, wherein the term multi-phase tablets includes, for example, the so called sandwich tablets, dry-coated tablets or bull eye tablets.

In step b) of the inventive process a water-soluble film is applied onto the rims that surround the cavity. The water-soluble film can be applied in the form of a ready-made single label for a single molded object or in the form of a film that covers a plurality of molded objects.

In a preferred process variant, the water-soluble film comprises one or more water-soluble polymer(s), preferably a material from the group (optionally acetalized) polyvinyl alcohol (PVAL), polyvinyl pyrrolidone, polyethylene oxide, gelatine, cellulose, and their derivatives and mixtures.

“Polyvinyl alcohols” (abbreviation PVAL, sometimes also PVOH) is the term for polymers with the general structure

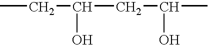

which comprise lesser amounts (ca. 2%) of structural units of the type

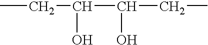

Typical commercial polyvinyl alcohols, which are offered as yellowish white powders or granules having degrees of polymerization in the range of approx. 100 to 2500 (molar weights of approximately 4,000 to 100,000 g/mol), have degrees of hydrolysis of 98-99 or 87-89 molar % and thus still have a residual acetyl group content. The manufacturers characterize the polyvinyl alcohols by stating the degree of polymerization of the initial polymer, the degree of hydrolysis, the saponification number and/or the solution viscosity.

The solubility of polyvinyl alcohols in water and in a few strongly polar organic solvents (formamide, dimethylformamide, dimethyl sulfoxide) is a function of the degree of hydrolysis; they are not attacked by (chlorinated) hydrocarbons, esters, fats or oils. Polyvinyl alcohols are classified as toxicologically inoffensive and are at least partially biologically degradable. The solubility in water can be reduced by post-treatment with aldehydes (acetalization), by complexation with Ni salts or Cu salts or by treatment with dichromates, boric acid or borax. The coatings of polyvinyl alcohol are substantially impermeable to gases such as oxygen, nitrogen, helium, hydrogen, carbon dioxide, but do allow water vapor to pass.

In the context of the present invention, it is preferred that the film material used in the inventive process at least partially includes a polyvinyl alcohol whose degree of hydrolysis is 70 to 100 molar %, preferably 80 to 90 molar %, particularly preferably from 81 to 89 molar %, and, in particular, from 82 to 88 molar %. In a preferred embodiment, the first film material used in the inventive process consists of at least 20 wt. %, particularly preferably of at least 40 wt. %, quite particularly preferably of at least 60 wt. % and particularly of at least 80 wt. % of a polyvinyl alcohol, whose degree of hydrolysis ranges from 70 to 100 molar %, advantageously 80 to 90 molar %, particularly preferably 81 to 89 molar % and particularly 82 to 88 molar %.

Preferably, polyvinyl alcohols of a defined molecular weight range are used for the film material, wherein according to the invention it is preferred that the film material includes a polyvinyl alcohol whose molecular weight lies in the range 10,000 to 100,000 gmol⁻¹, advantageously from 11,000 gmol⁻¹ to 90,000 gmol⁻¹, with particular preference from 12,000 to 80,000 gmol⁻¹, and, in particular, from 13,000 to 70,000 gmol⁻¹.

The degree of polymerization of such preferred polyvinyl alcohols lies between approximately 200 to approximately 2,100, preferably between approximately 220 to approximately 1,890, with particular preference between approximately 240 to approximately 1,680, and, in particular, between approximately 260 to approximately 1,500.

The above-described polyvinyl alcohols are widely commercially available, for example, under the trade name Mowiol® (Clariant). Examples of polyvinyl alcohols which are particularly suitable in the context of the present invention are Mowiol® 3-83, Mowiol® 4-88, Mowiol® 5-88, and Mowiol® 8-88.

Additional polyvinyl alcohols that are particularly suitable as film materials are to be found in the following table:

| | Degree of | Molecular Weight | Melting Point |
|---|---|---|---|
| Name | Hydrolysis [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® | 30-28 | 23.600 | 100 |
| 5407 | | | |
| Gohsefimer ® | 41-51 | 17.700 | 100 |
| LL02 | | | |

Additional polyvinyl alcohols suitable as film materials are ELVANOL® 51-05, 52-22, 50-42, 85-82, 75-15, T-25, T-66, 90-50, (trade mark of Du Pont), ALCOTEX® 72.5, 78, B72, F80/40, F88/4, F88/26, F88/40, F88/47, (trade mark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trade mark of Nippon Gohsei K.K.).

The water content of PVAL can be modified by post-treatment with aldehydes (acetalization) or ketones (ketalization). Polyvinyl alcohols, which are acetalized or ketalized with the aldehyde or ketone groups of saccharides or polysaccharides or their mixtures, have proved to be particularly preferred and because of their extremely good solubility in cold water, particularly advantageous. The reaction products of PVAL and starch are used most advantageously.

Moreover, the water-solubility can be adjusted and controlled to required values by complexation with Ni salts or Cu salts or by treatment with dichromates, boric acid or borax. The films of polyvinyl alcohol are substantially impenetrable to gases such as oxygen, nitrogen, helium, hydrogen, carbon dioxide, but do allow water vapor to pass.

Exemplary suitable water-soluble PVAL films are available under the trade name “SOLUBLON®” from Syntana Handelsgesellschaft E. Harke GmbH & Co. Their solubility in water can be adjusted exactly and films of this product series are available, which are soluble in the aqueous phase over all temperature ranges relevant to each application.

Polyvinyl pyrrolidones, abbreviated to PVP, can be described by means of the general formula:

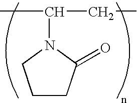

PVP are manufactured by radical polymerization of 1-vinyl pyrrolidone. Commercial PVP have molecular weights in the range 2,500 to 750,000 g/mol and are supplied as white, hygroscopic powders or as aqueous solutions.

Polyethylene oxides, abbreviated to PEOX, are polyalkylene glycols of the general formula

H—[O—CH₂—CH₂]ₙ—OH

which are manufactured industrially by the base catalyzed polyaddition of ethylene oxide (oxirane) in systems with the least possible water content and with ethylene glycol as the starting molecule. They have molecular weights in the range ca. 200-5,000,000 g/mol, corresponding to polymerization degrees n of ca. 5 to >100,000. Polyethylene oxides have an extremely low concentration of reactive hydroxyl end groups and display only weak glycol properties.

Gelatine is a polypeptide (molecular weight: approx. 15,000 to >250,000 g/mol) obtained principally by hydrolysis under acidic or alkaline conditions of the collagen present in the skin and bones of animals. The amino acid composition of gelatine corresponds largely to that of the collagen from which it was obtained, and varies as a function of its origin.

In the context of the inventive process, film materials are preferred, which include a polymer from the group starch and starch derivatives, cellulose and cellulose derivatives, particularly methyl cellulose and mixtures thereof.

Starch is a homoglycan in which the glucose units are attached by α-glycoside bonds. Starch is made up of two components of different molecular weight, namely ca. 20 to 30% straight-chain amylose (molecular weight ca. 50,000 to 150,000) and 70 to 80% of branched-chain amylopectin (molecular weight ca. 300,000 to 2,000,000). Small quantities of lipids, phosphoric acid and cations are also present. Whereas the amylose—on account of the bond in the 1,4-position—forms long, helical entwisted chains containing about 300 to 1,200 glucose molecules, the amylopectin chain branches through a 1,6-bond after—on average—25 glucose units to form a branch-like structure containing about 1,500 to 12,000 glucose molecules. Besides pure starch, starch derivatives obtainable from starch by polymer-analog reactions may also be used in the context of the present invention for the production of water-soluble coatings for the detergent, rinse agent and cleaning agent portions. These chemically modified starches include, for example, products of esterification or etherification reactions in which hydroxy hydrogen atoms have been substituted. However, starches in which the hydroxy groups have been replaced by functional groups that are not attached by an oxygen atom may also be used as starch derivatives. The group of starch derivatives includes, for example, alkali metal starches, carboxymethyl starches (CMS), starch esters and ethers and amino starches.

Pure cellulose has the formal empirical composition (C₆H₁₀O₅)ₙ and, formally, is a β-1,4-polyacetal of cellobiose that, in turn, is made up of two molecules of glucose. In this context, suitable celluloses consist of ca. 500 to 5,000 glucose units and consequently have average molecular weights of 50,000 to 500,000. In the context of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and amino celluloses.

Additional preferred film materials are characterized in that they comprise hydroxypropyl methyl cellulose (HPMC), which has a degree of substitution (average number of methoxy groups per anhydroglucose unit of the cellulose) from 1.0 to 2.0, preferably from 1.4 to 1.9, and a molar substitution (average number of hydroxypropyl groups per anhydroglucose unit of the cellulose) from 0.1 to 0.3, preferably from 0.15 to 0.25.

Processes according to the invention, wherein at least one of the added film materials is transparent or translucent, are preferred.

The film material used is preferably transparent. In the context of this invention, transparency is understood to mean that the transmittance in the visible spectrum of light (410 to 800 nm) is greater than 20%, advantageously greater than 30%, most preferably greater than 40% and in particular greater than 50%. Thus, as soon as a wavelength of the visible spectrum of light has a transmittance greater than 20%, then in the context of the invention it is to be considered as transparent.

Inventively manufactured agents, for whose manufacture transparent film material was employed, can comprise a stabilizer. In the context of the invention, stabilizers are materials that at least partially protect the ingredients enclosed by the film material from decomposition or deactivation from light irradiation. Antioxidants, UV-absorbers and fluorescent dyes have proven to be particularly suitable.

Preferred process variants are those wherein the thickness of at least one of the water-soluble films employed in the inventive process is between 5 and 2,000 μm, preferably between 10 and 1,000 μm, particularly preferably between 15 and 500 μm, quite particularly preferably between 20 and 200 μm and especially between 25 and 100 μm.

The films can be a single or multilayered film (laminate film). Independently of their chemical or physical composition, the water content of the film materials is preferably below 10 wt. %, particularly preferably below 7 wt. %, quite particularly preferably below 5 wt. % and especially below 4 wt. %.

The film applied in step b) particularly preferably covers not only the rim but additionally also the inner wall, particularly preferably the inner wall and the floor of the cavity.

Inventive manufacturing processes, in which the film applied in step b) covers the rim as well as the inner wall, preferably the inner wall and the floor of the cavity, are preferred.

In an additional preferred embodiment, the dimensions of the film applied in step b) are such that after the application of this film on the rim and the optional covering of the inner wall or the inner wall and the floor of the cavity, the film protrudes over the rim surrounding the cavity and can be at least partially attached to the neighboring side walls and floor surface of the molded object. In a process variant of this type, the molded object of the detergent or cleaning agent is “wrapped” in the second water-soluble film. In other words, besides the filled cavity and the rims surrounding the cavity, the side walls of the molded object of the detergent or cleaning agent, which are adjacent to the rims, are also at least partially covered with this film.

The water-soluble film applied in step b) is preferably not solely applied onto the rim immediately surrounding the cavity, but in addition preferably at least partially also covers the side walls of the molded object, which are adjacent to the rim.

### DETAILED DESCRIPTION OF THE INVENTION

Accordingly, a preferred subject matter is a process for manufacturing a detergent or cleaning agent dosing unit comprising the steps of: (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the rim; (c) filling the cavity; (d) applying a second water-soluble film over the filled cavity and sealing the cavity filled in step c) wherein the molded object of the detergent or cleaning agent is wrapped in the second water-soluble film and the cavity filled in step c) is sealed; characterized in that the film applied in step b) covers the rim and the side wall of the molded object of the detergent or cleaning agent.

Accordingly, an additional preferred subject matter of the present application is a process for manufacturing a detergent or cleaning agent dosing unit comprising the steps of: (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the rim; (c) filling the cavity; (d) applying a second water-soluble film over the filled cavity and sealing the cavity filled in step c) is sealed; wherein the film applied in step b) covers the rim as well as the inner wall of the cavity, but not its floor, as well as in addition the side wall of the molded object of the detergent or cleaning agent.

An additional preferred subject matter of the present application is a process for manufacturing a detergent or cleaning agent dosing unit comprising the steps of: (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the rim; (c) filling the cavity; (d) applying a second water-soluble film over the filled cavity and sealing the cavity filled in step c) is sealed; wherein the film applied in step b) covers the rim as well as the inner wall of the cavity and the floor of the cavity, as well as in addition the side wall of the molded object of the detergent or cleaning agent.

If the water-soluble film applied in step b) is intended to cover not only the rim but additionally also the inner wall and the floor of the cavity, then this film is preferably molded into the cavity of the molded object.

Manufacturing processes, wherein the film applied in step b) is molded into the cavity prior to filling, are inventively preferred. In this respect, the water-soluble film is preferably molded by means of a deep drawing process.

In the context of the present application, “Deep drawing processes” are those processes, in which a first film cladding material or filmy cladding material, after having been placed over a cavity, is molded into the cavity by the action of pressure and/or vacuum. The pressure can be generated by a tool and/or compressed air, which press the film into the cavity.

Moreover, particularly preferred processes are those in which the first film material is deep drawn into the cavity in step c), during which a partial vacuum is produced in the cavity of the molded object.

The partial vacuum can be produced by all pumps suited for this purpose known to the person skilled in the art, particularly preferably water jet pumps, liquid steam jet pumps, water ring pumps and reciprocating pumps that are employed for a low vacuum. Rotary vane pumps, external vane pumps, trochoid pumps and sorption vacuum pumps as well as Eton pumps and cryogenic pumps can be preferably employed, for example. Rotary vane pumps, diffusion pumps, Eton pumps, positive displacement pumps, turbo molecular pumps, sorption vacuum pumps, getter-ion pumps are preferred for creating a high vacuum.

In a preferred embodiment of the process according to the invention, the partial vacuum that is produced is between −100 and −1013 mbar, preferably between −200 and −1013 mbar, particularly preferably between −400 and −1013 mbar and especially between −800 and −1013 mbar.

In a preferred process variant, the employed packaging film is conditioned prior to molding. For this, particularly preferred inventive processes are those in which the packaging film is pre-treated by heating and/or solvent application prior to the deep drawing in step c). If the film material is pre-treated by heating before or during the deep drawing into the cavity of the molded object, then it is heated for up to 5 seconds, advantageously for 0.1 to 4 seconds, particularly preferably for 0.2 to 3 seconds and in particular for 0.4 to 2 seconds to a temperature above 60° C., advantageously above 80° C., particularly preferably between 100 and 120° C. and particularly to temperatures between 105 and 115° C. In preferred process variants, these types of pre-treated film materials mold themselves into the cavity of the molded object in step c) because of their own weight.

The effect of the vacuum not only enables the water-soluble film to be molded into the cavity of the molded object of the detergent or cleaning agent, but alternatively or in addition to this, a vacuum can also be used to fix the water-soluble film to the molded object in the course of one or a plurality of subsequent process steps. The filling is facilitated by fixing the film on the surface and the water-soluble film waste is reduced.

Manufacturing processes, wherein the film applied in step b) on the molded object is fixed by means of a vacuum prior to filling the cavity, are inventively preferred.

In a preferred process the film applied in step b) is adhesively joined with the molded object before filling the cavity.

The cavity is filled in step c) of the inventive process. Manufacturing processes in which the cavity is filled with a free-flowing substance are particularly preferred.

In the context of the present application, those processes are particularly preferred, in which, in step d), a free-flowing active detergent or cleaning substance is poured in. These solid or liquid free-flowing substances or mixtures of substances are preferably poured onto the film material in the cavity. Liquid(s) and/or gel(s) and/or powder and/or granulate(s) and/or extrudate(s) and/or compaction(s) are preferably employed as the free-flowing substances.

When particular, for example, powder, granulates or extrudates are employed as the solid free-flowing substances or mixture of substances, then these particulate substances or mixtures of substances have a particle size below 5,000 μm, advantageously less than 3,000 μm, preferably less than 1,000 μm, quite particularly preferably between 50 and 1,000 μm and especially between 100 and 800 μm.

In an additional preferred embodiment, the free-flowing active detergent or cleaning substance concerns a liquid. Here, in the context of this application, substances or mixtures of substances in their liquid state are referred to as liquids. In addition to liquid, pure substances, the term “liquid” therefore also includes solutions, suspensions, emulsions or melts. Those substances or mixtures of substances that are in the liquid state at 20° C. are preferably employed. The liquids comprise at least one substance from the group of the nonionic surfactants and/or the polymers and/or the organic solvents as the preferred ingredients. The liquid itself can exhibit a plurality of phases.

Liquids that exhibit a viscosity (Brookfield-Viscosimeter LVT-II at 20 rpm and 20° C., spindle 3) in the range from 500 to 100,000 mPas, preferably from 1,000 to 50,000 mPas, particularly preferably from 1,200 to 10,000 mPas and especially from 1,300 to 5,000 mPas are particularly preferred as the free-flowing substances or mixtures of substances. In comparison with high or low viscosity liquids, these types of viscous liquids or gels are advantageous, particularly in regard to their division into portions.

After filling the cavity in step c), a second water-soluble film is applied over the cavity in step d) and the filled cavity is sealed. The sealing is preferably accomplished by forming an adherent joint between the water-soluble films applied in steps b) and d).

Manufacturing processes, wherein the first and the second water-soluble film are adhesively joined together in step d), are preferred according to the invention.

The adherent joint is particularly preferably realized along a circumferential weld seam. This weld seam can be produced by a series of different methods. Those processes are preferred, in which the adherent joint is obtained by the action of adhesives and/or solvents and/or pressure or crimping. However, such inventive processes are particularly preferred, in which the water-soluble films applied in step b) and step d) are adhesively bonded by adhesion and/or heat sealing. Also, in the case of heat sealing, a circumferential weld seam is particularly preferred, i.e., a continuous weld seam that runs into itself. A range of different tools and processes is available to the person skilled in the art for heat sealing the water-soluble films.

In a first preferred embodiment, the heat sealing is accomplished by means of heated sealing tools.

In a second preferred embodiment, the heat sealing is accomplished by means of a laser beam.

In a third preferred embodiment, the heat sealing is accomplished by means of hot air.

The adherent joint of both the water-soluble films is preferably made in the area of the rim that circumscribes the cavity. Particularly preferably, not only an adherent joint is made between the first and the second water-soluble films, but at the same time an additional adherent joint is also created between the first water-soluble film and the rim of the molded object.

As already described above for the water-soluble film applied in step b), the water-soluble film applied in step d) preferably also serves not only to cover and seal the cavity filled in step c), but is also used to at least partially package the molded object of detergent or cleaning agent. For this purpose, a water-soluble film is applied in step d) over the filled cavity and due to the dimensions of the film, it extends over the rims that circumscribe the cavity and can be at least partially attached to the side walls and floor that limit the molded object. In a process variant of this type, the molded object of the detergent or cleaning agent is “wrapped” in the second water-soluble film. In other words, besides the filled cavity and the rim surrounding the cavity, the side walls of the molded object of the detergent or cleaning agent, which are adjacent to the rims, are also at least partially covered with this film.

Manufacturing processes, wherein the molded object of the detergent or cleaning agent is wrapped in the second water-soluble film in step d), are preferred according to the invention.

Accordingly, a preferred subject matter is a manufacturing process for a detergent or cleaning agent dosing unit comprising the steps of: (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the circumscribed rim; (c) filling the cavity; (d) applying a second water-soluble film over the filled cavity and sealing the cavity filled in step c), wherein the molded object of detergent or cleaning agent is wrapped in the second water-soluble film.

Bearing in mind the embodiments listed above, this preferred process variant can be varied in various ways. Thus, those process variations are particularly preferred, in which the water-soluble film applied in step b) of the process is attached onto the side walls of the molded object and covers it. Accordingly, an additional preferred subject matter is a manufacturing process for a detergent or cleaning agent dosing unit, including the steps of (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the circumscribed rim wherein
the film applied in step b) covers the rim and the side wall of the molded object of detergent or cleaning agent; or
the film applied in step b) covers the rim as well as the inner wall of the cavity, but not its floor, as well as in addition the side wall of the molded object of the detergent or cleaning agent; or
the film applied in step b) covers the rim as well as the inner wall of the cavity and the floor of the cavity, as well as in addition the side wall of the molded object of the detergent or cleaning agent.
a) filling the cavity;
   applying a second water-soluble film over the filled cavity and sealing the cavity filled in step c)
      wherein the molded object of detergent or cleaning agent is wrapped in the second water-soluble film in such a way that the water-soluble film covers the side walls of the molded object, based on the total surface, to at least 10%, preferably at least 50%, particularly to at least 80% and especially completely.

In particular, those processes are preferred, in which the water-soluble film applied in step b) is attached in such a way onto the molded object of detergent or cleaning agent that it covers not solely the side walls but in addition also the floor, i.e., the side wall of the molded object opposite the cavity opening. In this process variant the water-soluble films applied in steps b) and d) overlap in the region of the side walls of the molded object, resulting in both a significantly improved storage stability of the unpacked molded object and the impermeability of the filled cavity.

Accordingly, an additional preferred subject matter is a manufacturing process for a detergent or cleaning agent dosing unit comprising the steps of: (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the circumscribed rim; wherein
the film applied in step b) covers the rim and the side wall of the molded object of detergent or cleaning agent; or
the film applied in step b) covers the rim as well as the inner wall of the cavity, but not its floor, as well as in addition the side wall of the molded object of the detergent or cleaning agent; or
the film applied in step b) covers the rim as well as the inner wall of the cavity and the floor of the cavity, as well as in addition the side wall of the molded object of the detergent or cleaning agent.
c) filling the cavity;
d) applying a second water-soluble film over the filled cavity and sealing the cavity filled in step c)
b) applying a third water-soluble film onto the floor of the molded object.

In a preferred variant of this process, the dimensions of the third water-soluble film applied in step e) are such that this film covers not only the floor of the molded object but in addition also the side wall of the molded object, based on the total surface, to at least 10%, preferably at least 50%, particularly to at least 80% and especially completely. In this way, the water-soluble film once again overlaps in the region of the side walls of the molded object and improves the storage stability as well as the impermeability of the filled cavity.

Those process variants are preferred, in which the third water-soluble film applied in step e) is adhesively bonded with the first and/or second water-soluble film, preferably forming a water-soluble film layer that completely envelops the molded object of detergent or cleaning agent. The adherent bond is preferably obtained by employing the above described compositions and processes.

The above described four or five step processes are suitable for manufacturing molded objects of detergents or cleaning agents that are completely wrapped or packaged in water-soluble films. As described, this packaging can increase not only the storage stability but also the impermeability of the filled cavity. At the same time however, the molded objects of detergents or cleaning agents having an increasing packaging content are characterized by increasing decomposition times in aqueous wash liquid. These decomposition times could once again be reduced by those process variants, in which a complete envelopment of the molded object is avoided, for example, by a suitable sizing of the water-soluble films and/or by the use of perforated water-soluble films.

Consequently, inventive manufacturing processes are particularly preferred, in which the applied water-soluble films are designed and/or attached onto the molded object of detergent or cleaning agent such that said molded object is not completely enveloped with a water-soluble film layer.

The above described inventive compositions or the compositions manufactured according to the above described inventive processes, comprise active detergent and cleaning substances, preferably active detergent and cleaning substances from the group of builders, surfactants, polymers, bleaching agents, bleach activators, enzymes, glass corrosion inhibitors, corrosion inhibitors, disintegration auxiliaries, fragrances and perfume carriers. These preferred ingredients are more closely described below.

The builders include especially the zeolites, silicates, carbonates, organic co builders and also—where there are no ecological reasons preventing their use—phosphates.

Crystalline layer-forming silicate of the general formula NaMSiₓO₂ₓ₊₁. y H₂O are preferably employed, wherein M represents sodium or hydrogen, x is a number from 1.9 to 22, preferably 1.9 to 4, wherein particularly preferred values for x are 2, 3 or 4 and y stands for a number from 0 to 33, preferably from 0 to 20. The crystalline layer-forming silicates of the formula NaMSiₓO₂ₓ₊₁. y H₂O are marketed, for example, by Clariant GmbH (Germany) under the trade names Na-SKS. Examples of these silicates are Na-SKS-1, (Na₂Si₂₂O₄₅ x H₂O, Kenyait), (Na-SKS-2, Na₂Si₁₄O₂₉ x H₂O, Magadiit), Na-SKS-3 (Na₂Si₈O₁₇ x H₂O) or Na-SKS-4 (Na₂Si₄O₉.x H₂O, Makatit).

Crystalline, layered silicates of formula NaMSiₓO₂ₓ₊₁, in which x stands for 2, are particularly suitable for the purposes of the present invention. Both β- and also δ-sodium disilicates Na₂Si₂O₅ y H₂O) as well as additionally most notably Na-SKS-5 (α-Na₂Si₂O₅), Na-SKS-7 (β-Na₂Si₂O₅, Natrosilit), Na-SKS-9 (NaHSi₂O₅, Kanemit), Na-SKS-10 (NaHSi₂O₅ 3H₂O, Kanemit), Na-SKS-11 (t-Na₂Si₂O₅) and Na-SKS-13 (NaHSi₂O₅), are preferred but Na-SKS-6 (δ-Na₂Si₂O₅) is particularly preferred.

Detergents or cleaning agents preferably comprise a content by weight of crystalline layered silicates of formula NaMSiₓO₂ₓ₊₁. y H₂O of 0.1 to 20 wt. %, preferably 0.2 to 15 wt. % and particularly 0.4 to 10 wt. %, each based on the total weight of the agent.

Other useful builders are amorphous sodium silicates with a modulus (Na₂O:SiO₂ ratio) of 1:2 to 1:3.3, preferably 1:2 to 1:2.8 and especially 1:2 to 1:2.6, which preferably dissolve with a delay and exhibit multiple wash cycle properties. The delay in dissolution compared with conventional amorphous sodium silicates can have been obtained in various ways, for example, by surface treatment, compounding, compressing/compacting or by over-drying. In the context of the invention, the term “amorphous” is understood to encompass “X-ray amorphous.” In other words, the silicates do not produce any of the sharp X-ray reflexes typical of crystalline substances in X-ray diffraction experiments, but at best one or more maxima of the scattered X-radiation, which have a width of several degrees of the diffraction angle.

Alternatively or in combination with the above-cited amorphous sodium silicates, X-ray amorphous silicates are employed, whose silicate particles yield blurred or even sharp diffraction maxima in electron diffraction experiments. This can be interpreted to mean that the products have microcrystalline regions between ten and a few hundred nm in size, values of up to at most 50 nm and especially up to at most 20 nm being preferred. These types of X-ray amorphous silicates similarly possess a delayed dissolution in comparison with the customary water glasses. Compacted/densified amorphous silicates, compounded amorphous silicates and over dried X-ray-amorphous silicates are particularly preferred.

In the context of the present invention, detergents and cleaning agents preferably comprise silicate(s), preferably alkali silicates, particularly preferably crystalline or amorphous alkali disilicates in quantities of 3 to 60 wt. %, preferably 8 to 50 wt. % and especially 20 to 40 wt. %, each based on the weight of the detergent or cleansing composition.

Naturally, the generally known phosphates can also be added as builders, in so far that their use should not be avoided on ecological grounds. In the detergent and cleaning agent industry, among the many commercially available phosphates, the alkali metal phosphates are the most important and pentasodium or pentapotassium triphosphates (sodium or potassium tripolyphosphate) are particularly preferred.

Alkali metal phosphates” is the collective term for the alkali metal (more particularly sodium and potassium) salts of the various phosphoric acids, in which metaphosphoric acids (HPO₃)ₙ and orthophosphoric acid (H₃PO₄) and representatives of higher molecular weight can be differentiated. The phosphates combine several inherent advantages: they act as alkalinity sources, prevent lime deposits on machine parts and lime incrustations in fabrics and, in addition, contribute towards the cleansing power.

The industrially important phosphates are the pentasodium triphosphate, Na₅P₃O₁₀ (sodium tripolyphosphate) as well as the corresponding potassium salt pentapotassium triphosphate K₅P₃O₁₀ (potassium tripolyphosphate). According to the invention, the sodium potassium tripolyphosphates are again preferably employed.

In the context of the present invention, if phosphates are incorporated as the active detergent or cleaning substances in detergents or cleaning compositions, then preferred compositions comprise this/these phosphate(s), preferably alkali metal phosphate(s), particularly preferably pentasodium or pentapotassium triphosphate (sodium or potassium triphosphate) in quantities of 5 to 80 wt. %, preferably 15 to 75 wt. % and especially 20 to 70 wt. %, each based on the weight of the detergent or cleaning composition.

Additional builders are the alkalinity sources. Alkali metal hydroxides, alkali metal carbonates, alkali metal hydrogen carbonates, alkali metal sesquicarbonates, the cited alkali silicates, alkali metal silicates and mixtures of the cited materials are examples of alkalinity sources that can be used, the alkali carbonates being preferably used, especially sodium carbonate, sodium hydrogen carbonate or sodium sesquicarbonate in the context of this invention. A builder system comprising a mixture of tripolyphosphate and sodium carbonate is particularly preferred. A builder system comprising a mixture of tripolyphosphate and sodium carbonate and sodium disilicate is also particularly preferred. Because of their low chemical compatibility—in comparison with other builders—with the usual ingredients of detergents and cleaning compositions, the alkali metal hydroxides are preferably only incorporated in low amounts, advantageously in amounts below 10 wt. %, preferably below 6 wt. %, particularly preferably below 4 wt. % and particularly below 2 wt. %, each based on the total weight of the detergent or cleansing composition. Compositions that comprise less than 0.5 wt. %, based on the total weight, and in particular no alkali metal hydroxide, are particularly preferred.

Particularly preferred detergents and cleaning compositions comprise carbonate(s) and/or hydrogen carbonate(s), preferably alkali carbonate(s), particularly preferably sodium carbonate in quantities of 2 to 50 wt. %, preferably 5 to 40 wt. % and especially 7.5 to 30 wt. %, each based on the weight of the detergent or cleansing composition. Particularly preferred compositions comprise, based on the weight of the detergent or cleaning composition, less than 20 wt. %, advantageously less than 17 wt. %, preferably less than 13 wt. % and particularly less than 9 wt. % carbonate(s) and/or hydrogen carbonate(s), preferably alkali carbonates, particularly preferably sodium carbonate.

Organic co builders include, in particular, polycarboxylates/polycarboxylic acids, polymeric polycarboxylates, aspartic acid, polyacetals, dextrins, other organic co builders and phosphonates. These classes of substances are described below.

Useful organic builders are, for example, the polycarboxylic acids that can be used in the form of the free acid and/or their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, amino carboxylic acids, nitrilotriacetic acid (NTA), providing such use is not ecologically unsafe, and mixtures thereof. Besides their building effect, the free acids also typically have the property of an acidifying component and hence also serve to establish a relatively low and mild pH of detergents and cleaning compositions. Citric acid, succinic acid, glutaric acid, adipic acid, gluconic acid and any mixtures thereof are particularly mentioned in this regard.

Other suitable builders are additional polymeric polycarboxylates, for example, the alkali metal salts of polyacrylic or polymethacrylic acid, for example, those with a relative molecular weight of 500 to 70,000 g/mol.

Molecular weights mentioned in this specification for polymeric polycarboxylates are weight-average molecular weights M_{w} of the particular acid form which, fundamentally, were determined by gel permeation chromatography (GPC) equipped with a UV detector. The measurement was carried out against an external polyacrylic acid standard, which provides realistic molecular weight values by virtue of its structural similarity to the polymers investigated. These values differ significantly from the molecular weights measured against polystyrene sulfonic acids as the standard. The molecular weights measured against polystyrene sulfonic acids are generally significantly higher than the molecular weights mentioned in this specification.

Particularly suitable polymers are polyacrylates, which preferably have a molecular weight of 2,000 to 20,000 g/mol. By virtue of their superior solubility, preferred representatives of this group are again the short-chain polyacrylates, which have molecular weights of 2,000 to 10,000 g/mol and, more particularly, 3,000 to 5,000 g/mol.

Additional suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2,000 to 70,000 g/mol, preferably 20,000 to 50,000 g/mol and especially 30,000 to 40,000 g/mol.

The (co)polymeric polycarboxylates can be employed either as powders or as aqueous solutions. The (co)polymeric polycarboxylate content of the detergents or cleaning compositions is preferably from 0.5 to 20% by weight and in particular 3 to 10% by weight.

In order to improve the water solubility, the polymers can also comprise allylsulfonic acids as monomers, such as, for example, allyloxybenzenesulfonic acid and methallylsulfonic acid.

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Other preferred copolymers are those, which preferably contain acrolein and acrylic acid/acrylic acid salts or acrolein and vinyl acetate as monomers.

Exemplary polymers active for water softening are polymers with sulfonic acid groups, which are especially preferably employed.

Particularly preferred suitable polymers comprising sulfonic acid groups are copolymers of unsaturated carboxylic acids, monomers comprising sulfonic acid groups and optional additional ionic or non-ionogenic monomers.

In the context of the present invention, unsaturated carboxylic acids of the formula

R¹(R²)C═C(R³)COOH

are preferred monomers, in which R¹ to R³ independently of one another stand for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups or for —COOH or —COOR⁴, wherein R⁴ is a saturated or unsaturated, linear or branched hydrocarbon group containing 1 to 12 carbon atoms.

Among the unsaturated carboxylic acids corresponding to the above formula, acrylic acid (R¹═R²═R³═H), methacrylic acid (R¹═R²═H; R³═CH₃) and/or maleic acid (R¹═COOH; R²═R³═H) are particularly preferred.

The preferred monomers containing sulfonic acid groups are those of the formula,

R⁵(R⁶)C═C(R⁷)—X—SO₃H

are preferred monomers, in which R⁵ to R⁷ independently of one another stand for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups or for —COOH or —COOR⁴, wherein R⁴ is a saturated or unsaturated, linear or branched hydrocarbon group containing 1 to 12 carbon atoms and X stands for an optional spacer group selected from —(CH₂)ₙ— with n=0 to 4, —COO—(CH₂)ₖ— with k=1 to 6, —C(O)—NH—C(CHs)₂- and —C(O)—NH—CH(CH₂CH₃)—.

Among these monomers those of the formulas are preferred

H₂C═CH—X—SO₃H

H₂C═C(CH₃)—X—SO₃H

HO₃S—X—(R⁶)C═C(R⁷)—X—SO₃H

in which R⁶ and R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Accordingly, particularly preferred sulfonic acid-containing monomers are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethylacrylamide, sulfomethylmethacrylamide and water-soluble salts of the cited acids.

Additional ionic or non-ionogenic monomers particularly include ethylenically unsaturated compounds. Preferably, the content of these additional ionic or non-ionogenic monomers in the added polymers is less than 20 wt. %, based on the polymer. Particularly preferred polymers for use consist solely of monomers of the formula R¹(R²)C═C(R³)COOH and monomers of the formula R⁵(R⁶)C═C(R⁷)—X—SO₃H.

In summary copolymers of
i) unsaturated carboxylic acids of the formula R¹(R²)C═C(R³)COOH in which R¹ to R³ independently of one another stand for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, wherein R⁴ is a saturated or unsaturated, linear or branched hydrocarbon radical containing 1 to 12 carbon atoms,
ii) monomers that contain sulfonic acid groups of the formula

R⁵(R⁶)C═C(R⁷)—X—SO₃H,

in which R⁵ to R⁷ independently of one another stand for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or for —COOH or —COOR⁴, wherein R⁴ is a saturated or unsaturated, linear or branched hydrocarbon group containing 1 to 12 carbon atoms, and X stands for an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.
i) optional additional ionic or nonionic monomers.
   Additional particularly preferred copolymers consist of
i) one or a plurality of unsaturated carboxylic acids from the group acrylic acid, methacrylic acid and/or maleic acid
ii) one or a plurality of monomers containing sulfonic acid groups of the formulas:

H₂C═CH—X—SO₃H

H₂C═C(CH₃)—X—SO₃H

HO₃S—X—(R⁶)C═C(R⁷)—X—SO₃H

in which R⁶ and R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optional additional ionic or nonionic monomers.

The copolymers can contain monomers from groups (i) and (ii) and optionally (iii) in varying amounts, wherein all representatives of group (i) can be combined with all representatives of group (ii) and all representatives of group (iii). Particularly preferred polymers have defined structural units, which are described below.

For example, copolymers are preferred, which comprise structural units of the formula

—[CH₂—CHCOOH]ₘ—[CH₂—CHC(O)—Y—SO₃H]ₚ—

in which m and p each stand for a whole natural number between 1 and 2,000 and Y stands for a spacer group selected from substituted or unsubstituted aliphatic, aromatic or substituted aromatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

These polymers are produced by copolymerization of acrylic acid with an acrylic acid derivative containing sulfonic acid groups. If the acrylic acid derivative containing sulfonic acid groups is copolymerized with methacrylic acid, then another polymer results whose incorporation is likewise preferred. The appropriate copolymers comprise structural units of the formula

—[CH₂—C(CH₃)COOH]ₘ—[CH₂—CHC(O)—Y—SO₃H]ₚ—

in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

Entirely analogously, acrylic acid and/or methacrylic acid may also be copolymerized with methacrylic acid derivatives containing sulfonic acid groups, so that the structural units in the molecule are changed. Consequently, copolymers that comprise structural units of the formula

—[CH₂—CHCOOH]ₘ—[CH₂—C(CH₃)C(O)—Y—SO₃H]_{P}—

in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred, likewise preferred as copolymers that comprise structural units of the formula

—[CH₂—C(CH₃)COOH]ₘ—[CH₂—C(CH₃)C(O)—Y—SO₃H]ₚ—

in which m and p each stand for a whole natural number between 1 and 2,000 and Y stands for a spacer group selected from substituted or unsubstituted aliphatic, aromatic or substituted aromatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

Instead of acrylic acid and/or methacrylic acid or in addition to them, maleic acid can also be incorporated as the particularly preferred monomer from group i). In this way, one arrives at inventively preferred copolymers that comprise structural units of the formula

—[HOOCCH—CHCOOH]ₘ—[CH₂—CHC(O)—Y—SO₃H]ₚ—

in which m and p each stand for a whole natural number between 1 to 2,000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, for —O—(C₆H₄)—, for —NH—C(CH₃)₂— or —NH—CH(CH₂CH₃)— are preferred. In addition, copolymers are inventively preferred that comprise the structural units of formula

—[HOOCCH—CHCOOH]ₘ—[CH₂—C(CH₃)C(O)O—Y—SO₃H]ₚ—

in which m and p each stand for a whole natural number between 1 and 2,000 and Y stands for a spacer group selected from substituted or unsubstituted aliphatic, aromatic or substituted aromatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

In summary, copolymers are inventively preferred, which comprise structural units of the formulas

—[CH₂—CHCOOH]ₘ—[CH₂—CHC(O)—Y—SO₃H]ₚ—

—[CH₂—C(CH₃)COOH]ₘ—[CH₂—CHC(O)—Y—SO₃H]ₚ—

—[CH₂—CHCOOH]ₘ—[CH₂—C(CH₃)C(O)—Y—SO₃H]ₚ—

—[CH₂—C(CH₃)COOH]ₘ—[CH₂—C(CH₃)C(O)—Y—SO₃H]ₚ—

—[HOOCCH—CHCOOH]ₘ—[CH₂CHC(O)—Y—SO₃H]ₚ—

—[HOOCCH—CHCOOH]ₘ—[CH₂—C(CH₃)C(O)O—Y—SO₃H]ₚ—

in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

The sulfonic acid groups may be present in the polymers completely or partly in neutralized form, i.e., the acidic hydrogen atom of the sulfonic acid groups can be replaced by metal ions, preferably alkali metal ions and more particularly sodium ions, in some or all of the sulfonic acid groups. The addition of copolymers containing partly or fully neutralized sulfonic acid groups is preferred according to the invention.

The monomer distribution of the inventively preferred copolymers used ranges for copolymers that comprise only monomers defined in groups (i) and (ii) from preferably 5 to 95 wt. % (i) and (ii) respectively, particularly preferably 50 to 90 wt. % monomer from group (i) and 10 to 50 wt. % monomer from group (ii) respectively, based on the polymer.

Particularly preferred terpolymers are those that comprise 20 to 85 wt. % monomer from group (i), 10 to 60 wt. % monomer from group (ii) and 5 to 30 wt. % monomer from group (iii).

The molecular weight of the inventively preferred sulfo-copolymers used can be varied to adapt the properties of the polymer to the desired application requirement. Preferred detergents or cleaning compositions are those wherein the molecular weights of the copolymers are 2,000 to 200,000 gmol⁻¹, preferably 4,000 to 25,000 gmol⁻¹ and especially 5,000 to 15,000 gmol⁻¹.

Similarly, other preferred builders are polymeric amino dicarboxylic acids, salts or precursors thereof. Polyaspartic acids or their salts are particularly preferred.

Additional preferred builders are polyacetals that can be obtained by treating dialdehydes with polyol carboxylic acids that possess 5 to 7 carbon atoms and at least 3 hydroxyl groups. Preferred polyacetals are obtained from dialdehydes like glyoxal, glutaraldehyde, terephthalaldehyde as well as their mixtures and from polycarboxylic acids like gluconic acid and/or glucoheptonic acid.

Additional suitable organic builders are dextrins, for example, oligomers or polymers of carbohydrates that can be obtained by the partial hydrolysis of starches. The hydrolysis can be carried out using typical processes, for example, acidic or enzymatic catalyzed processes. The hydrolysis products preferably have average molecular weights in the range 400 to 500,000 g/mol. A polysaccharide with a dextrose equivalent (DE) of 0.5 to 40 and, more particularly, 2 to 30 is preferred, the DE being an accepted measure of the reducing effect of a polysaccharide in comparison with dextrose, which has a DE of 100. Both maltodextrins with a DE between 3 and 20 and dry glucose syrups with a DE between 20 and 37 and also yellow dextrins and white dextrins with relatively high molecular weights of 2,000 to 30,000 g/mol may be used.

The oxidized derivatives of such dextrins concern their reaction products with oxidizing agents that are capable of oxidizing at least one alcohol function of the saccharide ring to the carboxylic acid function.

Oxydisuccinates and other derivatives of disuccinates, preferably ethylenediamine disuccinate are also additional suitable cobuilders. Ethylenediamine-N,N′-disuccinate (EDDS) is preferably used here in the form of its sodium or magnesium salts. In this context, glycerine disuccinates and glycerine trisuccinates are also preferred. Suitable addition quantities in zeolite-containing and/or silicate-containing formulations range from 3 to 15% by weight.

Other useful organic co-builders are, for example, acetylated hydroxycarboxylic acids and salts thereof, which optionally may also be present in lactone form and which contain at least 4 carbon atoms, at least one hydroxyl group and at most two acid groups.

In addition, any compounds capable of forming complexes with alkaline earth metal ions may be used as co-builders.

The group of surfactants includes the nonionic, the anionic, the cationic and the amphoteric surfactants.

All nonionic surfactants known to the person skilled in the art can be used as the nonionic surfactants. As additional nonionic surfactants, alkyl glycosides that satisfy the general formula RO(G)ₓ can be added, in which R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1.0 and 10, preferably between 1.2 and 1.4.

Another class of preferred nonionic surfactants which may be used, either as the sole nonionic surfactant or in combination with other nonionic surfactants, are alkoxylated, preferably ethoxylated or ethoxylated and propoxylated fatty acid alkyl esters preferably containing 1 to 4 carbon atoms in the alkyl chain.

Nonionic surfactants of the amine oxide type, for example, N-coco alkyl-N,N-dimethylamine oxide and N-tallow alkyl-N,N-dihydroxyethylamine oxide, and the fatty acid alkanolamides may also be suitable. The quantity in which these nonionic surfactants are used is preferably no more than the quantity in which the ethoxylated fatty alcohols are used and, particularly no more than half that quantity.

Other suitable surfactants are polyhydroxyfatty acid amides corresponding to the formula,

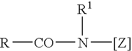

in which R stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the formula

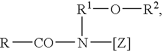

in which R is a linear or branched alkyl or alkenyl group containing 7 to 12 carbon atoms, R¹ is a linear, branched or cyclic alkyl group or an aryl radical containing 2 to 8 carbon atoms and R² is a linear, branched or cyclic alkyl group or an aryl group or an oxyalkyl group containing 1 to 8 carbon atoms, C₁₋₄-alkyl- or phenyl groups being preferred, and [Z] is a linear polyhydroxyalkyl group, of which the alkyl chain is substituted by at least two hydroxyl groups, or alkoxylated, preferably ethoxylated or propoxylated derivatives of that group.

[Z] is preferably obtained by reductive amination of a reducing sugar, for example, glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

The preferred surfactants are weakly foaming nonionic surfactants. Detergents or cleansing compositions, particularly cleaning compositions for automatic dishwashers, are especially preferred when they comprise nonionic surfactants from the group of the alkoxylated alcohols. Preferred nonionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain, e.g., linear and methyl-branched groups in the form of the mixtures typically present in oxo alcohol groups. Particularly preferred are, however, alcohol ethoxylates with linear groups from alcohols of natural origin with 12 to 18 carbon atoms, e.g., from coco-, palm-, tallow- or oleyl alcohol, and an average of 2 to 8 EO per mol alcohol. Exemplary preferred ethoxylated alcohols include C₁₂₋₁₄ alcohols with 3 EO or 4EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, as well as mixtures of C₁₂₋₁₄ alcohol with 3 EO and C₁₂₋₁₈ alcohol with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these nonionic surfactants, fatty alcohols with more than 12 EO can also be used. Examples of these are tallow fatty alcohol with 14 EO, 25 EO, 30 EO or 40 EO.

Accordingly, ethoxylated nonionic surfactant(s) prepared from C₆₋₂₀ monohydroxy alkanols or C₆₋₂₀ alkyl phenols or C₁₂₋₂₀ fatty alcohols and more than 12 mole, preferably more than 15 mole and especially more than 20 mole ethylene oxide per mole alcohol, are used with particular preference. A particularly preferred nonionic surfactant is obtained from a straight-chain fatty alcohol containing 16 to 20 carbon atoms (C₁₆₋₂₀ alcohol), preferably a C₁₈ alcohol, and at least 12 moles, preferably at least 15 moles and more preferably at least 20 moles of ethylene oxide. Of these nonionic surfactants, the narrow range ethoxylates are particularly preferred.

Moreover, combinations of one or more tallow fat alcohols with 20 to 30 EO with a silicone defoamer are particularly preferably used.

Nonionic surfactants that have a melting point above room temperature are used with particular preference. Nonionic surfactant(s) with a melting point above 20° C., preferably above 25° C., particularly preferably between 25 and 60° C. and especially between 26.6 and 43.3° C., is/are particularly preferred.

Suitable nonionic surfactants with a melting and/or softening point in the cited temperature range are, for example, weakly foaming nonionic surfactants that can be solid or highly viscous at room temperature. If nonionic surfactants are used that are highly viscous at room temperature, then it is preferred that they have a viscosity greater than 20 Pa s, preferably above 35 Pa s and especially above 40 Pa s. Nonionic surfactants that have a waxy consistency at room temperature are also preferred, depending on the application.

Nonionic surfactants from the group of the alkoxylated alcohols, particularly preferably from the group of the mixed alkoxylated alcohols and especially from the group of the EO-AO-EO-nonionic surfactants are likewise incorporated with particular preference.

Preferably, the room temperature solid nonionic surfactant additionally has propylene oxide units in the molecule. These PO units preferably make up as much as 25% by weight, more preferably as much as 20% by weight and, especially up to 15% by weight of the total molecular weight of the nonionic surfactant. Particularly preferred nonionic surfactants are ethoxylated monohydroxyalkanols or alkylphenols, which have additional polyoxyethylene-polyoxypropylene block copolymer units. The alcohol or alkylphenol component of these nonionic surfactant molecules preferably makes up more than 30 wt. %, more preferably more than 50 wt. % and most preferably more than 70 wt. % of the total molecular weight of these nonionic surfactants. Preferred compositions are characterized in that they comprise ethoxylated and propoxylated nonionic surfactants, in which the propylene oxide units in the molecule preferably make up as much as 25% by weight, more preferably as much as 20% by weight and, especially up to 15% by weight of the total molecular weight of the nonionic surfactant.

Preferred surfactants that are solid at room temperature are used and belong to the groups of the alkoxylated nonionic surfactants, more particularly the ethoxylated primary alcohols, and mixtures of these surfactants with structurally more complex surfactants, such as polyoxypropylene/polyoxyethylene/polyoxypropylene ((PO/EO/PO) surfactants). Such (PO/EO/PO) nonionic surfactants are characterized in addition as having good foam control

Other particularly preferred nonionic surfactants with melting points above room temperature contain 40 to 70% of a polyoxypropylene/polyoxyethylene/polyoxypropylene block polymer blend that contains 75% by weight of an inverted block copolymer of polyoxyethylene and polyoxypropylene with 17 moles of ethylene oxide and 44 moles of propylene oxide and 25% by weight of a block copolymer of polyoxyethylene and polyoxypropylene initiated with trimethylolpropane and containing 24 moles of ethylene oxide and 99 moles of propylene oxide per mole of trimethylolpropane.

Particularly preferred nonionic surfactants in the context of the present invention have proved to be weakly foaming nonionic surfactants, which have alternating ethylene oxide and alkylene oxide units. Among these, the surfactants with EO-AO-EO-AO blocks are again preferred, wherein one to ten EO or AO groups respectively are linked together, before a block of the other groups follows. Here, nonionic surfactants of the general formula

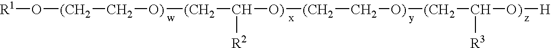

are preferred, in which R¹ stands for a linear or branched, saturated or a mono- or polyunsaturated C₆₋₂₄-alkyl or alkenyl group, each group R² or R³ independently of one another is selected from —CH₃, —CH₂CH₃, —CH₂CH₂—CH₃, CH(CH₃)₂, and the indices w, x, y, z independently of one another stand for whole numbers from 1 to 6.

The preferred nonionic surfactants of the previous formula can be manufactured by known methods from the corresponding alcohols R¹—OH and ethylene- or alkylene oxide. The group R¹ in the previous formula can vary depending on the origin of the alcohol. When natural sources are used, the group R¹ has an even number of carbon atoms and generally is not branched, the linear alcohols of natural origin with 12 to 18 carbon atoms, for example, coconut, palm, tallow or oleyl alcohol being preferred. The alcohols available from synthetic sources are, for example, Guerbet alcohols or mixtures of methyl branched in the 2-position or linear and methyl branched groups, as are typically present in oxo alcohols. Independently of the type of alcohol used for the manufacture of the nonionic surfactants comprised in the agents, nonionic surfactants are preferred, wherein R¹ in the previous formula stands for an alkyl group with 6 to 24, preferably 8 to 20, particularly preferably 9 to 15 and particularly 9 to 11 carbon atoms.

In addition to propylene oxide, especially butylene oxide can be the alkylene oxide unit that alternates with the ethylene oxide unit in the preferred nonionic surfactants. However, also other alkylene oxides are suitable, in which R² or R³ independently of one another are selected from —CH₂CH₂—CH₃ or CH(CH₃)₂. Preferably, nonionic surfactants of the previous formula are used, in which R² or R³ stand for a group —CH₃, w and x independently of one another stand for values of 3 or 4 and y and z independently of one another stand for values of 1 or 2.

In summary, especially nonionic surfactants are preferred that have a C₉₋₁₅ alkyl group with 1 to 4 ethylene oxide units, followed by 1 to 4 propylene oxide units, followed by 1 to 4 ethylene oxide units, followed by 1 to 4 propylene oxide units. These surfactants exhibit the required low viscosity in aqueous solution and according to the invention are used with particular preference.

Surfactants of the general formula R¹—CH(OH)CH₂O-(AO)_{w}-(A′O)ₓ-(A″O)_{y}-(A″O)_{z}—R², in which R¹ and R² independently of one another stands for a linear or branched, saturated or unsaturated or mono- or polyunsaturated C₂₋₄₀ alkyl or alkenyl group; A, A′, A″ and A′″ independently of one another stands for a group from the group —CH₂CH₂, —CH₂CH₂—CH₂, —CH₂—CH(CH₃), —CH₂—CH₂—CH₂—CH₂—, —CH₂—CH(CH₃)—CH₂—, —CH₂—CH(CH₂—CH₃); and w, x, y and z stand for values between 0.5 and 90, wherein x, y and/or z can also be 0, are inventively preferred.

Such end capped polyoxyalkylated nonionic surfactants are particularly preferred that, in accordance with the formula R¹O[CH₂CH₂O]ₓCH₂CH(OH)R², possess in addition to a group R¹ that stands for linear or branched, saturated or unsaturated, aliphatic or aromatic hydrocarbon groups containing 2 to 30 carbon atoms, preferably containing 4 to 22 carbon atoms, an additional linear or branched, saturated or unsaturated, aliphatic or aromatic hydrocarbon group R² containing 1 to 30 carbon atoms, wherein x stands for values between 30 and 80 and especially for values between 30 and 60.

Surfactants of the formula R¹O[CH₂CH(CH₃)O]ₓ[CH₂CH₂O]_{y}CH₂CH(OH)R² are particularly preferred, in which R¹ stands for a linear or branched aliphatic hydrocarbon group with 4 to 18 carbon atoms or mixtures thereof, R² means a linear or branched hydrocarbon group with 2 to 26 carbon atoms or mixtures thereof and x stands for values between 0.5 and 1.5 and y stands for a value of at least 15.

Additional particularly preferred surfactants are those end capped polyoxyalkylated nonionic surfactants of the formula R¹O[CH₂CH₂O]ₓ[CH₂CH(R³)O]_{y}CH₂CH(OH)R², in which R¹.and R² independently of one another stand for linear or branched, saturated or mono- or polyunsaturated hydrocarbon groups with 2 to 26 carbon atoms, R³ independently of each other is selected from —CH₃, —CH₂CH₃, —CH₂CH₂—CH₃, —CH(CH₃)₂, preferably —CH₃, however, and x and y independently of one another stand for values between 1 and 32, wherein surfactants with R³=—CH₃ and values for x from 15 to 32 and y from 0.5 and 1.5 are quite particularly preferred.

Other preferred nonionic surfactants are the end-capped poly(oxyalkylated) nonionic surfactants corresponding to the formula R¹O[CH₂CH(R³)O]ₓ[CH₂]ₖCH(OH)[CH₂]ⱼOR², in which R¹ and R² stand for linear or branched, saturated or unsaturated, aliphatic or aromatic hydrocarbon groups with 1 to 30 carbon atoms, R³ stands for H or for a methyl, ethyl, n-propyl, isopropyl, n-butyl, 2-butyl or 2-methyl-2-butyl group, x stands for values between 1 and 30, k and j for values between 1 and 12, preferably between 1 and 5. Each R³ in the above formula R¹O[CH₂CH(R³)O]ₓ[CH₂]ₖCH(OH)[CH₂]ⱼOR² can be different for the case where x≧2. R¹ and R² are preferably linear or branched, saturated or unsaturated, aliphatic or aromatic hydrocarbon groups containing 6 to 22 carbon atoms, groups containing 8 to 18 carbon atoms being particularly preferred. H, —CH₃ or —CH₂CH₃ are particularly preferred for the group R³. Particularly preferred values for x are in the range from 1 to 20 and more particularly in the range from 6 to 15.

As described above, each R³ in the above formula can be different for the case where x≧2. By this means, the alkylene oxide unit in the straight brackets can be varied. If, for example, x has a value of 3, the substituent R³ may be selected to form ethylene oxide (R³═H) or propylene oxide (R³═CH₃) units which may be joined together in any order, for example, (EO)(PO)(EO), (EO)(EO)(PO), (EO)(EO)(EO), (PO)(EO)(PO), (PO)(PO)(EO) and (PO)(PO)(PO). The value 3 for x was selected by way of example and may easily be larger, the range of variation increasing with increasing x-values and including, for example, a large number of (EO) groups combined with a small number of (PO) groups or vice versa.

Particularly preferred end-capped poly(oxyalkylated) alcohols corresponding to the above formula have values for both k and j of 1, so that the above formula can be simplified to R¹O[CH₂CH(R³)O]ₓCH₂CH(OH)CH₂OR². In this last formula, R¹, R² and R³ are as defined above and x stands for a number from 1 to 30, preferably 1 to 20 and especially 6 to 18. Surfactants in which the substituents R¹ and R² have 9 to 14 carbon atoms, R³ stands for H and x takes a value of 6 to 15 are particularly preferred.

The cited carbon chain lengths and degrees of ethoxylation or alkoxylation of the above-mentioned nonionic surfactants constitute statistically average values that can be a whole or a fractional number for a specific product. Due to the manufacturing process, commercial products of the cited formulas do not consist in the main of one sole representative, but rather are a mixture, wherein not only the carbon chain lengths but also the degrees of ethoxylation or alkoxylation can be average values and thus be fractional numbers.

Of course, the above-mentioned nonionic surfactants can not only be employed as single substances, but also as surfactant mixtures of two, three, four or more surfactants. Accordingly, surfactant mixtures do not refer to mixtures of nonionic surfactants that as a whole fall under one of the above cited general formulas, but rather refer to such mixtures that comprise two, three, four or more nonionic surfactants that can be described by the different above-mentioned general formulas.

When the anionic surfactants are components of dishwasher detergents, their content, based on the total weight of the agent, is advantageously less than 4% by weight, preferably less than 2% by weight and quite particularly preferably less than 1% by weight.-%. Dishwasher detergents, which comprise no anionic surfactants, are particularly preferred.

Cationic and/or amphoteric surfactants can be added instead of, or in combination with the cited surfactants.

As the cationic active substances, cationic compounds of the following formulas can be incorporated for example:

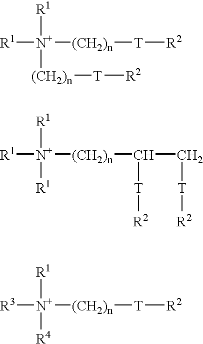

in which each group R¹, independently of one another, is selected from C₁₋₆-alkyl, -alkenyl or -hydroxyalkyl groups; each group R², independently of one another, is selected from C₈₋₂₈ alkyl or -alkenyl groups; R³═R¹ or (CH₂)ₙ-T-R²; R⁴═R1 or R² or (CH₂)ₙ-T-R²; T=—CH₂—, —O—CO— or —CO—O— and n is an integer from 0 to 5.

In dishwasher detergents, the content of cationic and/or amphoteric surfactants is advantageously less than 6% by weight, preferably less than 4% by weight, quite particularly preferably less than 2% by weight and in particular less than 1% by weight. Dishwasher detergents, which comprise no cationic or amphoteric surfactants, are particularly preferred.

The group of polymers includes, in particular the active detergent polymers or active cleansing polymers, for example, the rinsing polymers and/or polymers active for water softening. Generally, in addition to nonionic polymers, also cationic, anionic or amphoteric polymers are suitable for incorporation in detergents or cleaning compositions.

In the context of the present invention, “cationic polymers” are polymers that carry a positive charge in the polymer molecule. These can be realized, for example, by (alkyl) ammonium groups present in the polymer chain or other positively charged groups. Particularly preferred cationic polymers come from the groups of the quaternized cellulose derivatives, the polysiloxanes having quaternized groups, the cationic guar derivatives, the polymeric dimethyl diallyl ammonium salts and their copolymers with esters and amides of acrylic acid and methacrylic acid, the copolymers of vinyl pyrrolidone with quaternized derivatives of dialkylamino acrylate and -methacrylate, the vinyl pyrrolidone/methoimidazolinium chloride copolymers, the quaternized polyvinyl alcohols or the polymers listed under the INCI descriptions Polyquaternium 2, Polyquaternium 17, Polyquaternium 18 and Polyquaternium 27.

In the context of the present invention, “amphoteric polymers” are polymers that also possess, in addition to a positively charged group in the polymer chain, additional negatively charged groups or monomer units. These groups can concern, for example, carboxylic acids, sulfonic acids or phosphonic acids.

Preferred detergents or cleansing agents, in particular preferred dishwasher detergents, are those that comprise a polymer a) that possesses monomer units of the formula R¹R²C═CR³R⁴, in which each group R¹, R², R³, R⁴ independently of each other is selected from hydrogen, derivatized hydroxyl groups, C₁ to C₃₀ linear or branched alkyl groups, aryl, aryl substituted C₁₋₃₀ linear or branched alkyl groups, polyalkoxylated alkyl groups, heteroatomic organic groups having at least one positive charge without charged nitrogen, at least one quaternized nitrogen atom or at least one amino group with a positive charge in the pH range 2 to 11, or salts thereof, with the proviso that at least one group R¹, R², R³, R⁴ is a heteroatomic organic group with at least one positive charge without charged nitrogen, at least one quaternized nitrogen atom or at least one amino group with a positive charge.

In the scope of the present application, particularly preferred cationic or amphoteric polymers comprise as the monomer unit a compound of the general formula

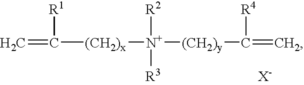

in which R¹ and R⁴ independently of one another stands for a linear or branched hydrocarbon group with 1 to 6 carbon atoms; R² and R³ independently of one another stand for an alkyl, hydroxyalkyl or aminoalkyl group, in which the alkyl group is linear or branched and has 1 to 6 carbon atoms, wherein it is preferably a methyl group; x and y independently of one another stand for whole numbers between 1 and 3. X⁻ represents a counter ion, preferably a counter ion from the group chloride, bromide, iodide, sulfate, hydrogen sulfate, methosulfate, lauryl sulfate, dodecylbenzene sulfonate, p-toluene sulfonate (tosylate), cumene sulfonate, xylene sulfonate, phosphate, citrate, formate, acetate or mixtures thereof.

Preferred groups R¹ and R⁴ in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Quite particularly preferred polymers are those that possess a cationic monomer unit of the above general formula, in which R¹ and R⁴ stand for H, R² and R³ stand for methyl, and x and y are each 1. The monomer units corresponding to the formula

H₂C═CH—(CH₂)—N⁺(CH₃)₂—(CH₂)—CH═CH₂X⁻

are also designated as DADMAC (diallyl dimethyl ammonium chloride) for the case where X⁻=chloride.

Additional particularly preferred cationic or amphoteric polymers comprise a monomer unit of the general formula

R¹HC═CR²—C(O)—NH—(CH₂)—N⁺R³R⁴R⁵

in which R¹, R², R³, R⁴ and R⁵ independently of one another stand for linear or branched, saturated or unsaturated alkyl, or hydroxyalkyl group with 1 to 6 carbon atoms, preferably for a linear or branched alkyl group selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂-0)ₙH, and x stands for a whole number between 1 and 6.

In the context of the present application, quite particularly preferred polymers possess a cationic monomer unit of the above general formula, in which R¹ stands for H, and R², R³, R⁴ and R⁵ stand for methyl, and x stands for 3. The monomer units corresponding to the formula

H₂C═C(CH₃)—C(O)—NH—(CH₂)ₙ—N⁺(CH₃)₃X⁻

are also designated as MAPTAC (methylacrylamidopropyl trimethyl ammonium chloride) for the case where X^{\tilde{-}}=chloride.

According to the invention, preferred polymers are used that comprise diallyl dimethyl ammonium salts and/or acrylamidopropyl trimethyl ammonium salts as monomer units.

The previously mentioned polymers possess not only cationic groups but also anionic groups or monomer units. These anionic monomer units come, for example, from the group of the linear or branched, saturated or unsaturated carboxylates, the linear or branched, saturated or unsaturated phosphonates, the linear or branched, saturated or unsaturated sulfates or the linear or branched, saturated or unsaturated sulfonates. Preferred monomer units are acrylic acid, the (meth)acrylic acid, the (dimethyl)acrylic acid, the (ethyl)acrylic acid, the cyanoacrylic acid, the vinylacetic acid, the allylacetic acid, the crotonic acid, the maleic acid, the fumaric acid, the cinnamic acid and its derivatives, the allylsulfonic acids, such as, for example, allyloxybenzene sulfonic acid and methallyl sulfonic acid or the allylphosphonic acids.

Preferred usable amphoteric polymers come from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkyl methacrylate/alkylaminoethyl methacrylate/alkyl methacrylate copolymers as well as the copolymers of unsaturated carboxylic acids, cationically derivatized unsaturated carboxylic acids and optionally additional ionic or nonionic monomers.

Preferred usable zwitterionic polymers come from the group of the acrylamidoalkyl trialkyl ammonium chloride/acrylic acid copolymers as well as their alkali metal- and ammonium salts, the acrylamidoalkyl trialkyl ammonium chloride/methacrylic acid copolymers as well as their alkali metal- and ammonium salts and their methacroylethylbetaine/methacrylate copolymers.

In addition, preferred amphoteric polymers are those that include methacrylamidoalkyl trialkyl ammonium chloride and dimethyl (diallyl) ammonium chloride as the cationic monomer in addition to one or more anionic monomers.

Particularly preferred amphoteric polymers come from the group of methacrylamidoalkyl-trialkyl ammonium chloride/dimethyl (diallyl) ammonium chloride/acrylic acid copolymers, the methacrylamidoalkyl trialkyl ammonium chloride/dimethyl (diallyl) ammonium chloride/methacrylic acid copolymers and the methacrylamidoalkyl trialkyl ammonium chloride/dimethyl (diallyl) ammonium chloride/alkyl(meth)acrylic acid copolymers as well as their alkali metal and ammonium salts.

In particular, preferred amphoteric polymers are from the group of the methacrylamidopropyl trimethyl ammonium chloride/dimethyl (diallyl) ammonium chloride/acrylic acid copolymers, the methacrylamidopropyl trimethyl ammonium chloride/dimethyl (diallyl) ammonium chloride/acrylic acid copolymers and the methacrylamidopropyl trimethyl ammonium chloride/dimethyl (diallyl) ammonium chloride/alkyl(meth)acrylic acid copolymers as well as their alkali metal and ammonium salts.

In a particularly preferred embodiment of the present invention, the polymers are in preconditioned form. Suitable pre-conditioning of the polymers include inter alia
encapsulation of the polymers by means of water-soluble or water-dispersible coating materials, preferably by means of water-soluble or water-dispersible natural or synthetic polymers;
encapsulation of the polymers by means of water-insoluble, meltable coating materials, preferably by means of water-insoluble coating materials from the group of the waxes or paraffins having a melting point above 30° C.;
co-granulation of the polymers with inert carrier materials, preferably with carrier materials from the group of the active detergent or cleaning agent substances, particularly preferably from the group of the builders or co builders.

Detergents or cleaning compositions comprise the above-mentioned cationic and/or amphoteric polymers in amounts between 0.01 and 10 wt. %, each based on the total weight of the detergent or cleaning composition. However, in the context of the present application, those detergents or cleaning compositions are preferred, in which the weight content of the cationic and/or amphoteric polymers is between 0.01 and 8 wt. %, preferably between 0.01 and 6 wt. %, preferably between 0.01 and 4 wt. %, particularly preferably between 0.01 and 2 wt. % and especially between 0.01 and 1 wt. %, each based on the total weight of the automatic dishwasher detergent.

The bleaching agents are particularly preferred with an incorporated active detergent or cleaning substance. Among the compounds, which serve as bleaching agents and liberate H₂O₂ in water, sodium percarbonate, sodium perborate tetrahydrate and sodium perborate monohydrate are of particular importance. Examples of additional bleaching agents that may be used are peroxypyrophosphates, citrate perhydrates and H₂O₂-liberating peracidic salts or peracids, such as perbenzoates, peroxyphthalates, diperoxyazelaic acids, phthaloimino peracids or diperoxydodecanedioic acids.

Moreover, bleaching agents from the group of the organic bleaching agents can also be used. Typical organic bleaching agents are the diacyl peroxides, such as, e.g., dibenzoyl peroxide. Additional typical organic bleaching agents are the peroxy acids, wherein the alkylperoxy acids and the arylperoxy acids may be named as examples. Preferred representatives are (a) peroxybenzoic acid and ring-substituted derivatives thereof, such as alkyl peroxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamido peroxycaproic acid, N-nonenylamido peradipic acid and N-nonenylamido persuccinates and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic acid).

Chlorine- or bromine-releasing substances can also be incorporated as bleaching agents. Suitable chlorine- or bromine-releasing materials include, for example, heterocyclic N-bromamides and N-chloramides, for example, trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethyl hydantoin, are also suitable.

According to the invention, detergents or cleaning compositions, particularly dishwasher detergents, are preferred that comprise 1 to 35 wt. %, preferably 2.5 to 30 wt. %, particularly preferably 3.5 to 20 wt. % and particularly 5 to 15 wt. % bleaching agent, preferably sodium percarbonate.

The active oxygen content of the detergents or cleaning compositions, particularly dishwasher detergents, based on the total weight of the composition, preferably ranges between 0.4 and 10 wt. %, particularly preferably between 0.5 and 8 wt. % and particularly between 0.6 and 5 wt. %. Particularly preferred agents possess an active oxygen content above 0.3 wt. %, preferably above 0.7 wt. %, particularly preferably above 0.8 wt. % and particularly above 1.0 wt. %.

The detergents or cleansing agents can comprise bleach activators in order to achieve an improved bleaching action on washing or cleaning at temperatures of 60° C. and below. Bleach activators, which can be used are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular, 1,5-diacetyl-2,4-dioxohexahydro-1,3,5-triazine (DADHT), acylated glycolurils, in particular, tetraacetyl glycoluril (TAGU), N-acylimides, in particular n-nonanoyl- or isononanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran, n-methyl-morpholinium-acetonitrile-ethyl sulfate (MMA) as well as acetylated sorbitol and mannitol or their mixtures (SORMAN), acylated sugar derivatives, in particular pentaacetyl glucose (PAG), pentaacetyl fructose, tetraacetyl xylose and octaacetyl lactose as well as acetylated, optionally N-alkylated glucamine and gluconolactone, and/or N-acylated lactams, for example, N-benzoyl caprolactam. Hydrophilically substituted acyl acetals and acyl lactams are also preferably used. Combinations of conventional bleach activators may also be used.

These bleach activators are preferably employed in amounts of up to 10 wt. %, particularly 0.1 to 8 wt. %, especially 2 to 8 wt. % and particularly preferably 2 to 6 wt. %, each based on the total weight of the bleach activator-containing composition.

In the context of the present application, additional preferred added bleach activators are compounds from the group of the cationic nitriles, particularly cationic nitriles of the formula

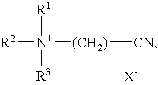

in which R¹ stands for —H, —CH₃, a C₂₋₂₄ alkyl or alkenyl group, a substituted C₂₋₂₄ alkyl or alkenyl group having at least one substituent from the group of —Cl, —Br, —OH, —NH₂, —CN, an alkyl or alkenylaryl group having a C₁₋₂₄ alkyl group or for an alkyl or alkenylaryl group having a C₁₋₂₄ alkyl group and at least an additional substituent on the aromatic ring, R² and R³, independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 5 or 6 and X is an anion.

A cationic nitrile of the formula is particularly preferred

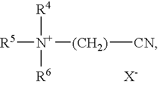

in which R⁴, R⁵ and R⁶ independently of one another are selected from —CH₃, —CH₂—CH₃, —CH₂—CH₂—CH₃, —CH(CH₃)—CH₃, wherein R⁴ can also be —H and X is an anion, wherein preferably R⁵═R⁶=—CH₃ and in particular R⁴═R⁵═R⁶=—CH₃ and compounds of the formulas (CH₃)₃N⁽⁺⁾CH₂—CNX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂CN X⁻, or (HO—CH₂—CH₂)₃N⁽⁺⁾CH₂—CNX⁻ are particularly preferred, wherein once again the cationic nitrile of the formula (CH₃)₃N⁽⁺⁾CH₂—CNX⁻, in which X⁻ stands for an anion selected from the group chloride, bromide, iodide, hydrogen sulfate, methosulfate, p-toluene sulfonate (tosylate) or xylene sulfonate, is particularly preferred.

In addition to, or instead of the conventional bleach activators mentioned above, bleach catalysts may also be incorporated. These substances are bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands, as well as cobalt-, iron-, copper- and ruthenium-ammine complexes may also be employed as the bleach catalysts.

Bleach-boosting transition metal complexes, more particularly containing the central atoms Mn, Fe, Co, Cu, Mo, V, Ti and/or Ru, preferably selected from the group of manganese and/or cobalt salts and/or complexes, particularly preferably the cobalt (ammine) complexes, cobalt (acetate) complexes, cobalt (carbonyl) complexes, chlorides of cobalt or manganese and manganese sulfate, are also used in typical quantities, preferably in a quantity of up to 5% by weight, especially in a quantity of 0.0025% by weight to 1% by weight and particularly preferably in a quantity of 0.01% by weight to 0.25% by weight, based on the total weight of the bleach activator-containing agent. However, in special cases more bleach activator may also be employed.

Enzymes can be incorporated to increase the washing or cleaning performance of detergents or cleaning agents. These particularly include proteases, amylases, lipases, hemicellulases, cellulases or oxidoreductases as well as preferably their mixtures. In principle, these enzymes are of natural origin; improved variants based on the natural molecules are available for use in detergents and accordingly they are preferred. The detergents or cleaning compositions preferably comprise enzymes in total quantities of 1×10⁻⁶ to 5 weight percent based on active protein. The protein concentration can be determined using known methods, for example, the BCA Process or the biuret process.

Preferred proteases are those of the subtilisin type. Examples of these are subtilisins BPN′ and Carlsberg as well as the additional developed forms, the protease PB92, the subtilisins 147 and 309, the alkaline protease from Bacillus lentus, subtilisin DY and those enzymes of the subtilases no longer however classified in the stricter sense as subtilisines thermitase, proteinase K and the proteases TW3 and TW7.

Examples of additional useable amylases according to the invention are the α-amylases from Bacillus licheniformis, from B. amyloliquefaciens, from B. stearothermophilus, from Aspergillus niger and A. oryzae as well as their improved additional developments for use in washing and cleaning agents. Moreover, for these purposes, attention should be drawn to the α-amylase from Bacillus sp. A 7-7 (DSM 12368) and the cyclodextrin-glucanotransferase (CGTase) from B. agaradherens (DSM 9948).

According to the invention, lipases or cutinases can also be incorporated, particularly due to their triglyceride cleaving activities, but also in order to produce in situ peracids from suitable preliminary steps. These include the available or additional developed lipases originating from Humicola lanuginosa (Thermomyces lanuginosus), particularly those with the amino acid substitution D96L. Moreover, suitable cutinases, for example, are those that were originally isolated from Fusarium solani pisi and Humicola insolens. Additional suitable are lipases or cutinases whose starting enzymes were originally isolated from Pseudomonas mendocina and Fusarium solanii.

In addition, enzymes, which are summarized under the term hemicellulases, can be added. These include, for example, mannanases, xanthanlyases, pectinlyases (=pectinases), pectinesterases, pectatlyases, xyloglucanases (=xylanases), pullulanases and β-glucanases.

To increase the bleaching action, oxidoreductases, for example, oxidases, oxygenases, katalases, peroxidases, like halo-, chloro-, bromo-, lignin-, glucose- or manganese-peroxidases, dioxygenases or laccases (phenoloxidases, polyphenoloxidases) can be incorporated according to the invention. Advantageously, additional, preferably organic, particularly preferably aromatic compounds are added that interact with the enzymes to enhance the activity of the relative oxidoreductases or to facilitate the electron flow (mediators) between the oxidizing enzymes and the stains over strongly different redox potentials.

The enzymes can be added in each established form according to the prior art. Included here, for example, are solid preparations obtained by granulation, extrusion or lyophilization, or particularly for liquid agents or agents in the form of gels, enzyme solutions, advantageously highly concentrated, of low moisture content and/or mixed with stabilizers.

As an alternative application form, the enzymes can also be encapsulated, for example, by spray-drying or extrusion of the enzyme solution together with a preferably natural polymer or in the form of capsules, for example, those in which the enzyme is embedded in a solidified gel, or in those of the core-shell type, in which an enzyme-containing core is covered with a water-, air- and/or chemical-impervious protective layer. Additional active principles, for example, stabilizers, emulsifiers, pigments, bleaches or colorants can be applied in additional layers. Such capsules are made using known methods, for example, by vibratory granulation or roll compaction or by fluid bed processes. Advantageously, these types of granulates, for example, with an applied polymeric film former are dust-free and as a result of the coating are storage stable.

In addition, it is possible to formulate two or more enzymes together, so that a single granulate exhibits a plurality of enzymatic activities.

A protein and/or enzyme can be protected, particularly in storage, against deterioration such as, for example, inactivation, denaturation or decomposition, for example, through physical influences, oxidation or proteolytic cleavage. An inhibition of the proteolysis is particularly preferred during microbial preparation of proteins and/or enzymes, particularly when the compositions also contain proteases. For this use, detergents or cleansing agents can comprise stabilizers; the provision of these types of agents represents a preferred embodiment of the present invention.

Preferably, one or a plurality of enzymes and/or enzyme preparations, preferably solid protease preparations and/or amylase preparations are incorporated in quantities from 0.1 to 5 wt. %, preferably from 0.2 to 4.5 wt. % and in particular from 0.4 to 4 wt. %, each based on the total enzyme-containing composition.

Glass corrosion inhibitors prevent the occurrence of smears, streaks and scratches as well as iridescence on the glass surface of glasses washed in an automatic dishwasher. Preferred glass corrosion inhibitors come from the group of magnesium salts and zinc salts and magnesium complexes and zinc complexes.

The spectrum of the inventively preferred zinc salts, advantageously of organic acids, particularly preferably of organic carboxylic acids, ranges from salts that are difficulty soluble or insoluble in water, i.e., with a solubility below 100 mg/l, preferably below 10 mg/l, or especially below 0.01 mg/l, to such salts with solubilities in water greater than 100 mg/l, preferably over 500 mg/l, particularly preferably over 1 g/l and especially over 5 g/l (all solubilities at a water temperature of 20° C.). The first group of zinc salts includes zinc citrate, zinc oleate and zinc stearate, the group of soluble zinc salts includes, for example, zinc formate, zinc acetate, zinc lactate and zinc gluconate.

A particular advantageous glass corrosion inhibitor is at least one zinc salt of an organic carboxylic acid, particularly preferably a zinc salt from the group zinc stearate, zinc oleate, zinc gluconate, zinc acetate, zinc lactate and/or zinc citrate. Zinc ricinoleate, zinc abietate and zinc oxalate are also preferred.

In the context of the present invention, the content of zinc salt in the detergent or cleaning compositions is advantageously between 0.1 and 5 wt. %, preferably between 0.2 and 4.0 wt. % and especially between 0.4 and 3 wt. %, and the content of zinc in the oxidized form (calculated as Zn²⁺) between 0.01 and 1 wt. %, preferably between 0.02 and 0.5 wt. % and especially between 0.04 and 0.2 wt. % respectively, based on the total weight of the composition containing the glass corrosion inhibitor.

Corrosion inhibitors serve to protect the tableware or the machine, silver protection agents being particularly important in automatic dishwashing. Substances known from the prior art can be incorporated. Above all, silver protectors selected from the group of triazoles, benzotriazoles, bisbenzotriazoles, aminotriazoles, alkylaminotriazoles and the transition metal salts or complexes may generally be used. Benzotriazole and/or alkylaminotriazole are particularly preferably used. 3-Amino-5-alkyl-1,2,4-triazoles or their physiologically compatible salts are inventively preferred, wherein these substances are preferably employed in a concentration of 0.001 to 10 wt. %, preferably 0.0025 to 2 wt. %, particularly preferably 0.01 to 0.04 wt. %. Preferred acids for the salt formation are hydrochloric acid, sulfuric acid, phosphoric acid, carbonic acid, sulfurous acid, organic carboxylic acids like acetic acid, glycolic acid, citric acid and succinic acid. 5-Pentyl-, 5-heptyl-, 5-nonyl-, 5-undecyl-, 5-isononyl-, 5-versatic-10-acid alkyl-3-amino-1,2,4-triazoles as well as mixtures of these substances are quite particularly efficient.

Moreover, agents containing active chlorine are frequently encountered in cleaning formulations, which can significantly reduce corrosion of the silver surface. In chlorine-free cleaning products, particular use is made of oxygen-containing and nitrogen-containing organic redox-active compounds, such as dihydric and trihydric phenols, e.g., hydroquinone, pyrocatechol, hydroxyhydroquinone, gallic acid, phloroglucinol, pyrogallol and derivatives of these classes of compound. Salts and complexes of inorganic compounds, such as salts of the metals Mn, Ti, Zr, Hf, V, Co and Ce are also frequently used. Preference is given in this context to the transition metal salts selected from the group consisting of manganese and/or cobalt salts and/or complexes, particularly preferably cobalt ammine complexes, cobalt acetato complexes, cobalt carbonyl complexes, the chlorides of cobalt or of manganese, and manganese sulfate. Zinc compounds may also be used to prevent corrosion of tableware.

Redox-active substances may be added instead of, or in addition to the above described silver protection agents, e.g., the benzotriazoles. These substances are preferably inorganic redox-active substances from the group of salts and/or complexes of manganese, titanium, zirconium, hafnium, vanadium, cobalt or cerium, in which the cited metals exist in the valence states II, III, IV, V or VI.

The metal salts or complexes used should be at least partially soluble in water. Suitable counter ions for the salt formation include all usual mono, di or trivalent negatively charged inorganic anions, e.g., oxide, sulfate, nitrate, fluoride and also organic anions such as e.g., stearate.

Particularly preferred metal salts and/or metal complexes are selected from the group MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃, as well as their mixtures, such that the metal salts and/or metal complexes selected from the group MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ are employed with particular preference.

The inorganic redox-active substances, particularly metal salts or metal complexes are preferably coated, i.e., completely coated with a water-impermeable material that is, however easily soluble at the cleaning temperatures, in order to prevent any premature decomposition or oxidation during storage. Preferred coating materials, which are applied using known processes, for instance hot melt coating process from Sandwik in the food industry, are paraffins, microwaxes, waxes of natural origin such as candelilla wax, carnuba wax, beeswax, higher-melting alcohols such as, for example, hexadecanol, soaps or fatty acids.

The cited metal salts and/or metal complexes are comprised in the cleaning compositions, preferably in a quantity of 0.05 to 6 wt. %, preferably 0.2 to 2.5 wt. %, each based on the total weight of the composition containing the corrosion inhibitor.

In order to facilitate the disintegration of the preconditioned molded bodies, disintegration aids or tablet disintegrators may be incorporated in the agents to shorten their disintegration times. Tablet disintegrators or disintegration accelerators are generally understood to mean auxiliaries that ensure a rapid disintegration of tablets in water or other media and the speedy release of the active substance.

These substances, which are also known as “disintegrators” by virtue of their effect, increase in volume on contact with water so that, firstly, their own volume increases (swelling) and secondly, a pressure can also be generated by the release of gases, causing the tablet to disintegrate into smaller particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

The disintegration aids are preferably incorporated in quantities of 0.5 to 10 wt. %, advantageously from 3 to 7 wt. % and especially from 4 to 6 wt. %, each based on the total weight of the agent containing the disintegration aid.

Preferred disintegrators that are used are based on cellulose, and therefore the preferred detergent and cleaning agents comprise such a cellulose-based disintegrator in quantities from 0.5 to 10% by weight, advantageously 3 to 7% by weight and especially 4 to 6% by weight. Pure cellulose has the formal empirical composition (C₆H₁₀O₅)ₙ and, formally, is a β-1,4-polyacetal of cellobiose that, in turn, is made up of two molecules of glucose. In this context, suitable celluloses consist of ca. 500 to 5,000 glucose units and consequently have average molecular weights of 50,000 to 500,000. In the context of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and amino celluloses. The cellulose derivatives mentioned are preferably not used on their own, but rather in the form of a mixture with cellulose as cellulose-based disintegrators. The content of cellulose derivatives in mixtures such as these is preferably below 50% by weight and more preferably below 20% by weight, based on the cellulose-based disintegrator. A particularly preferred cellulose-based disintegrator is pure cellulose, free from cellulose derivatives.

The cellulose, used as the disintegration aid, is advantageously not added in the form of fine particles, but rather conveyed in a coarser form prior to addition to the premix that will be compressed, for example, granulated or compacted. The particle sizes of such disintegrators are mostly above 200 μm, advantageously with at least 90 wt. % between 300 and 1600 μm and particularly at least 90 wt. % between 400 and 1200 μm.

Microcrystalline cellulose can be used as an additional cellulose-based disintegration aid, or as an ingredient of this component. This microcrystalline cellulose is obtained by the partial hydrolysis of cellulose, under conditions, which only attack and fully dissolve the amorphous regions (ca. 30% of the total cellulosic mass) of the cellulose, leaving the crystalline regions (ca. 70%) intact. Subsequent disaggregation of the microfine cellulose, obtained by hydrolysis, yields microcrystalline celluloses with primary particle sizes of ca. 5 μm and, for example, which are compactable to granules with an average particle size of 200 μm.

Preferred disintegration aids, advantageously a disintegration aid based on cellulose, preferably in granular, co-granulated or compacted form, are comprised in the disintegration aid-containing agent in quantities of 0.5 to 10 wt. %, preferably 3 to 7 wt. % and particularly 4 to 6 wt. %, each based on the total weight of the disintegration aid-containing agent.

Moreover, according to the invention, it can be preferred to incorporate additional effervescing systems as the tablet disintegration aids. The gas-evolving effervescent system can consist of a single substance, which liberates a gas on contact with water. Among these compounds, particular mention is made of magnesium peroxide, which liberates oxygen on contact with water. Normally, however, the gas-liberating effervescent system consists of at least two ingredients that react with one another to form gas. Although various possible systems could be used, for example, systems releasing nitrogen, oxygen or hydrogen, the effervescent system used in the detergent and cleansing agent should be selected with both economic and ecological considerations in mind. Preferred effervescent systems consist of alkali metal carbonate and/or -hydrogen carbonate and an acidifying agent capable of releasing carbon dioxide from the alkali metal salts in aqueous solution.

Suitable acidifiers, which liberate carbon dioxide from alkali salts in aqueous solution, are, for example, boric acid and alkali metal hydrogen sulfates, alkali metal dihydrogen phosphates and other inorganic salts Preferably, however, organic acidifiers are used, citric acid being a particularly preferred acidifier. Preferred acidifiers in the effervescing system are from the group of organic di-, tri- and oligocarboxylic acids or their mixtures.

In the context of the present invention, suitable perfume oils or fragrances include individual odoriferous compounds, for example, synthetic products of the ester, ether, aldehyde, ketone, alcohol and hydrocarbon type. However, mixtures of various odoriferous substances, which together produce an attractive fragrant note, are preferably used. Perfume oils such as these may also contain natural odoriferous mixtures obtainable from vegetal sources, for example, pine, citrus, jasmine, patchouli, rose or ylang-ylang oil.

The volatility of an odoriferous substance is crucial for its perceptibility, whereby in addition to the nature of the functional groups and the structure of the chemical compound, the molecular weight also plays an important role. Thus, the majority of odoriferous substances have molecular weights up to 200 daltons, and molecular weights of 300 daltons and above are quite an exception. Due to the different volatilities of odoriferous materials, the smell of a perfume or fragrance composed of a plurality of odoriferous substances changes during evaporation, the impressions of odor being subdivided into the “top note,” “middle note” or “body” and “end note” or “dry out.” As the perception of smell also depends to a large extent on the intensity of the odor, the top note of a perfume or fragrance consists not solely of highly volatile compounds, whereas the end note consists to a large extent of less volatile, i.e., tenacious odoriferous substances. In the composition of perfumes, higher volatile odoriferous substances can be bound, for example, onto particular fixatives, whereby their rapid evaporation is impeded. In the following subdivision of perfumes into “more volatile” or “tenacious” perfumes, nothing is mentioned about the odor impression and additional, whether the relevant perfume is perceived as the top note or body note.

The fragrances may be directly incorporated, although it can also be of advantage to apply the fragrances on carriers that due to a slower fragrance release ensure a long lasting fragrance. Suitable carrier materials are, for example, cyclodextrins, the cyclodextrin/perfume complexes optionally being coated with other auxiliaries.

### Colorants.

Preferred colorants, which are not difficult for the person skilled in the art to choose, have a high storage stability, are not affected by the other ingredients of the agent or by light and do not have any pronounced substantivity for the substrates such as glass, ceramics or plastic dishes being treated with the colorant-containing agent, so as not to color them.

Care must be taken when choosing the colorant that the colorants possess a high storage stability and are insensitive towards light. At the same time, the different stabilities of colorants towards oxidation must also be borne in mind when choosing suitable colorants. In general, water-insoluble colorants are more stable to oxidation than are water-soluble colorants. The concentration of the colorant in the detergents or cleaning compositions, is varied depending on the solubility and hence also on the propensity to oxidation. For colorants that are readily soluble in water, colorant concentrations in the range of 10⁻² to 10⁻³ wt. % are typically selected. For the less readily water-soluble, but due to their brilliance, particularly preferred pigment dyes, their suitable concentration in detergents or cleaning compositions, in contrast, is typically several 10⁻³ to 10⁻⁴ wt. %.

Dyes are preferred that can be oxidatively destroyed in the washing process, as well as mixtures thereof with suitable blue colorants, the “blue toners.” It has also proved advantageous to employ dyes that are soluble in water or in liquid organic substances at room temperature. Anionic dyes, for example, anionic nitroso dyes, are suitable.

In addition to the components described in detail above, the detergents and cleaning agents can comprise additional ingredients that additional improve the application technological and/or esthetic properties of the agents. Preferred agents comprise one or a plurality of materials from the group of the electrolytes, pH-adjustors, fluorescent agents, hydrotropes, foam inhibitors, silicone oils, anti-redeposition agents, optical brighteners, graying inhibitors, shrink inhibitors, anti-creasing agents, color transfer inhibitors, antimicrobials, germicides, fungicides, antioxidants, antistats, ironing auxiliaries, water proofing and impregnation agents, swelling and anti-pilling agents, sequestrants and UV absorbers.

A large number of the most varied salts can be employed as the electrolytes from the group of the inorganic salts. Preferred cations are the alkali and alkali earth metals, preferred anions are the halides and sulfates. The addition of NaCl or MgCl₂ to the detergents or cleaning agents is preferred from the industrial manufacturing point of view.

The addition of pH adjustors can be considered for bringing the pH of the detergents or cleaning agents into the desired range. Any known acid or alkali can be added, in so far as their addition is not forbidden on technological or ecological grounds or grounds of protection of the consumer. The amount of these adjustors does not normally exceed 1 wt. % of the total formulation.

Examples of the foam inhibitors include inter alia soaps, oils, fats, paraffins or silicone oils, optionally deposited on carrier materials. Inorganic salts, such as carbonates or sulfates, cellulose derivatives or silicates as well as their mixtures are examples of suitable carrier materials. In the context of the present application, preferred compositions comprise paraffins, preferably unbranched paraffins (n-paraffins) and/or silicones, preferably linear polymeric silicones that have the structure (R₂SiO)ₓ and which are also called silicone oils. These silicone oils are usually clear, colorless, neutral, odorless, hydrophobic liquids with a molecular weight between 1,000 and 150,000, and viscosities between 10 and 1,000,000 mPas.

Suitable anti-redeposition agents, also referred to as soil repellents are, for example, nonionic cellulose ethers such as methyl cellulose and methyl hydroxypropyl cellulose with a content of methoxy groups of 15 to 30 wt. % and hydroxypropyl groups of 1 to 15 wt. %, each based on the nonionic cellulose ether, as well as polymers of phthalic acid and/or terephthalic acid or their derivatives known from the prior art, particularly polymers of ethylene terephthalates and/or polyethylene glycol terephthalates or anionically and/or nonionically modified derivatives thereof. From these, the sulfonated derivatives of the phthalic acid polymers and the terephthalic acid polymers are particularly preferred.

Optical brighteners “whiteners” can be added to detergents or cleaning agents in order to eliminate graying and yellowing of the treated textiles. These materials absorb onto the fiber and effect a brightening and pseudo bleach effect in that the invisible ultraviolet radiation is converted into visible radiation, wherein the ultraviolet light absorbed from sunlight is irradiated away as weak blue fluorescence and results in pure white for the yellow shade of the grayed or yellowed washing. Suitable compounds derive, for example, from the substance classes of 4,4′-diamino-2,2′-stilbenedisulfonic acids (flavonic acids), 4,4′-distyrylbiphenylene, methylumbelliferone, coumarone, dihydroquinolinones, 1,3-diarylpyrazolines, naphthoic acid imides, benzoxazole-, benzisoxazole- and benzimidazole-systems as well as heterocyclic substituted pyrene derivatives.

Graying inhibitors have the function of maintaining the dirt that was removed from the fibers suspended in the washing liquor, thereby preventing the dirt from resettling. Water-soluble colloids of mostly organic nature are suitable for this, for example, the water-soluble salts of polymeric carboxylic acids, glue, gelatines, salts of ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the above-mentioned starch products, e.g., degraded starches, aldehyde starches, etc. Polyvinyl pyrrolidone can also be used. Additional anti-graying inhibitors that can be used are cellulose ethers such as carboxymethyl cellulose (Na salt), methyl cellulose, hydroxyalkyl celluloses and mixed ethers such as methyl hydroxyethyl cellulose, methyl hydroxypropyl cellulose, methyl carboxymethyl cellulose and mixtures thereof.

As fabric surfaces, particularly of rayon, spun rayon, cotton and their mixtures can wrinkle of their own accord because the individual fibers are sensitive to flexion, bending, pressing and squeezing perpendicular to the fiber direction, the agents can comprise synthetic crease-protection agents. They include, for example, synthetic products based on fatty acids, fatty acid esters, fatty acid amides, fatty acid alkylol esters, fatty acid alkylol amides or fatty alcohols that have been mainly treated with ethylene oxide, or products based on lecithin or modified phosphoric acid esters.

Repellency and impregnation processes serve to furnish the textiles with substances that prevent soil deposition or facilitate their washability. Preferred repellency and impregnation agents are perfluorinated fatty acids also in the form of their aluminum or zirconium salts, organic silicates, silicones, polyacrylic acid esters with perfluorinated alcohol components or polymerizable compounds coupled with perfluorinated acyl or sulfonyl groups. Antistats can also be comprised. The soil repellent finish with repellency and impregnation agents is often classified as an easy-care finish. The penetration of the impregnation agent in the form of solutions or emulsions of the appropriate active substances can be facilitated by the addition of wetting agents that lower the surface tension. An additional application area for repellency and impregnation agents is the water-repellent finishing of textile goods, tents, awnings, leather etc., in which contrary to waterproofing, the fabric pores are not blocked, and the material therefore remains breathable (water-repellent finishing). The water-repellents used for water-repellent finishing coat textiles, leather, paper, wood, etc. with a very thin layer of hydrophobic groups, such as long chain alkyl or siloxane groups. Suitable water-repellent agents are, e.g., paraffins, waxes, metal soaps etc. with added aluminum- or zirconium salts, quaternary ammonium compounds with long chain alkyl groups, urea derivatives, fatty acid modified melamine resins, salts of chromium complexes, silicones, organo-tin compounds and glutardialdehyde as well as perfluorinated compounds. The finished water-repellent materials do not feel greasy; nevertheless, water droplets form drops on them, just like on greased materials, without wetting them. Thus, silicone-impregnated fabrics, for example, have a soft feel and are water and soil repellent; spots of ink, wine, fruit juices and the like are easier to remove.

Antimicrobial agents can be employed to combat microorganisms. Depending on the antimicrobial spectrum and the action mechanism, antimicrobial agents are classified as bacteriostatic agents and bactericides, fungistatic agents and fungicides, etc. Important representatives of these groups are, for example, benzalkonium chlorides, alkylaryl sulfonates, halophenols and phenol mercuric acetate, although these compounds can also be totally dispensed with.

The agents can comprise additional antioxidants in order to prevent undesirable changes caused by oxygen and other oxidative processes to the detergents and cleaning agents and/or the treated fabric surfaces. This class of compounds includes, for example, substituted phenols, hydroquinones, pyrocatechols and aromatic amines as well as organic sulfides, polysulfides, dithiocarbamates, phosphites and phosphonates.

An increased wear comfort can result from the additional use of antistats. Antistats increase the surface conductivity and thereby allow an improved discharge of built-up charges. Generally, external antistats are substances with at least one hydrophilic molecule ligand and provide a more or less hygroscopic film on the surfaces. These mainly interface active antistats can be subdivided into nitrogen-containing (amines, amides, quaternary ammonium compounds), phosphorus-containing (phosphoric acid esters) and sulfur-containing (alkyl sulfonates, alkyl sulfates) antistats. Lauryl (or stearyl) dimethyl benzyl ammonium chlorides are also suitable antistats for textiles or as additives to detergents, resulting in an additional finishing effect.

Silicone derivatives, for example, can be added to improve the water-absorption capacity, the wettability of the treated textiles and to facilitate ironing of the treated textiles. They additionally improve the final rinse behavior of the detergents or cleansing agents by their foam-inhibiting properties. Exemplary preferred silicone derivatives are polydialkylsiloxanes or alkylarylsiloxanes, in which the alkyl groups possess one to five carbon atoms and are totally or partially fluorinated. Preferred silicones are polydimethylsiloxanes that can be optionally derivatized and then are aminofunctional or quaternized or possess Si—OH, Si—H and/or SiCl bonds. Additional preferred silicones are the polyalkylene oxide-modified polysiloxanes, i.e., polysiloxanes that, for example, possess polyethylene glycols, as well as the polyalkylene oxide-modified dimethylpolysiloxanes.

Finally, according to the invention, UV absorbers can also be employed, which are absorbed on the treated textiles and improve the light stability of the fibers. Compounds, which possess these desired properties, are, for example, the efficient radiationless deactivating compounds and derivatives of benzophenone having substituents in position(s) 2- and/or 4. Also suitable are substituted benzotriazoles, acrylates that are phenyl-substituted in position 3 (cinnamic acid derivatives), optionally with cyano groups in position 2, salicylates, organic Ni complexes, as well as natural substances such as umbelliferone and the endogenous urocanic acid.

In the context of the invention, protein hydrolyzates, due to their fiber-care action, are additional preferred active substances from the field of detergents and cleaning agents. Protein hydrolyzates are product mixtures obtained by acid-, base- or enzyme-catalyzed degradation of proteins (albumins). According to the invention, the added protein hydrolyzates can be of both vegetal as well as of animal origin. Animal protein hydrolyzates are, for example, elastin, collagen, keratin, milk protein, and silk protein hydrolyzates, which can also be present in the form of their salts. According to the invention, it is preferred to use protein hydrolyzates of vegetal origin, e.g., soya, almond, rice, pea, potato and wheat protein hydrolyzates. Although it is preferred to add the protein hydrolyzates as such, optionally other mixtures containing amino acid or individual amino acids can also be added in their place, such as arginine, lysine, histidine or pyroglutamic acid. Likewise, it is possible to add derivatives of protein hydrolyzates, e.g., in the form of their fatty acid condensation products.

1. A process for manufacturing a detergent or cleaning agent dosing unit comprising the steps of: (a) providing a molded object of detergent or cleaning agent having at least one cavity having an orifice on the surface of the molded object wherein the cavity has a rim circumscribed about the edge of the orifice and wherein the rim has a width of at least 1 mm; (b) applying a first water-soluble film onto the rim; (c) filling the cavity; (d) applying a second water-soluble film over the filled cavity and sealing the cavity filled in step c).

2. The manufacturing process of claim 1 wherein the width of the rim is at least 1.5 mm

3. The manufacturing process of claim 2 wherein the width is at least 2 mm

4. The manufacturing process of claim 3 wherein the width of the rim is from 2 to 10 mm.

5. The manufacturing process of claim 1 wherein the film applied in step b) covers the rim as well as the inner wall of the cavity.

6. The manufacturing process of claim 5 wherein the film also covers the floor of the cavity.

7. The manufacturing process of claim 6 wherein the film applied in step b) additional covers the side wall of the molded object of detergent or cleaning agent.

8. The manufacturing process of claim 1 wherein the film applied in step b) covers the rim and the side wall of the molded object of detergent or cleaning agent.

9. The manufacturing process of claim 1 wherein the film applied in step b) is molded into the cavity prior to the filling.

10. The manufacturing process of claim 1 wherein the film applied in step b) is fixed to the molded object by means of a vacuum prior to the filling of the cavity.

11. The manufacturing process of claim 1 wherein the film applied in step b) is adhesively joined with the molded object prior to the filling of the cavity.

12. The manufacturing process of claim 1 wherein the cavity is filled with a free-flowing substance.

13. The manufacturing process of claim 1 wherein the first and the second water-soluble film are adhesively joined with one another in step d).

14. The manufacturing process of claim 1 wherein the molded object of detergent or cleaning agent is wrapped in the second water soluble film in step (d).

15. The manufacturing process of claim 1 additional comprising step e) wherein a third water-soluble film is applied on the side of the molded object opposite to the cavity orifice of the molded object.

16. The manufacturing process of claim 15 wherein the third water-soluble film applied in step e) is adhesively bonded with the first and/or second water-soluble film.

17. The manufacturing process of claim 16 wherein the third water-soluble film completely envelops the molded object of detergent or cleaning agent.

18. The manufacturing process of claim 1 wherein the applied water-soluble films are attached onto the molded object of detergent or cleaning agent such that the molded object of detergent or cleaning agent is not completely enveloped with a water-soluble film layer.
